(19) United States
(12) Patent Application Publication
(10) Pub. No.: US 2002/0169789 A1
(43) Pub. Date: Nov. 14, 2002

(54) System and method for accessing, organizing, and presenting data

(76) Inventors: Ali Kutay, Palo Alto, CA (US); Cihan Akin, Redwood City, CA (US); Eliahu Albek, San Francisco, CA (US); Erhan C. Akin, Foster City, CA (US); Hakan Akin, San Mateo, CA (US); John Gilbert, Belmont, CA (US); Stephen Wilkes, Santa Clara, CA (US)

Correspondence Address: Florin Corie, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/875,416

(22) Filed: Jun. 5, 2001

Related U.S. Application Data
(60) Provisional application No. 60/209,713, filed on Jun. 5, 2000.
(60) Provisional application No. 60/270,837, filed on Feb. 23, 2001.

(51) Int. Cl. G06F 15/16; G06F 17/00; G06F 17/30; G06F 7/00

(52) U.S. Cl. 707/104.1; 709/219; 707/3

(57) ABSTRACT

A system and method for accessing, organizing, and presenting data are described. A first user interface area is presented to enable a user to define a data reference structure for one or more data sources from multiple disparate data sources, the one or more data sources containing data to be provided to the user. A second user interface area is presented to enable the user to create one or more data structures corresponding to the data reference structure and connected to the one or more data sources. A third user interface area is presented to enable the user to define application business logic to be performed on data in connection with the one or more data structures. A fourth user interface area is presented to enable the user to create presentation logic to display data in an output view. Finally, a fifth user interface area is presented to enable the user to define an action that triggers the application business logic.

The present application claims the benefit of U.S. Provisional Patent Application Serial No. 60/209,713, filed on Jun. 5, 2000 and entitled “METHODS AND SYSTEMS FOR ACCESSING, ORGANIZING, PRESENTING, AND VIEWING DATA,” and further claims the benefit of U.S. Provisional Patent Application Serial No. 60/270,837, filed on Feb. 23, 2001 and entitled “SYSTEM AND METHOD FOR ACCESSING, ORGANIZING, PRESENTING, AND VIEWING DATA.”

### FIELD OF THE INVENTION

The present invention relates generally to data representation and, more particularly, to a system and method for creating a source document and presenting the source document to a user in a target format.

### BACKGROUND

Nowadays, in the so-called “information age,” users are being presented with ever-increasing volumes of information. The presentation format of such information should ideally allow an information user quickly to assess the relevance of a large number of information items, and then efficiently to access information items that are deemed to be of relevance and interest.

The broader acceptance of the Internet, specifically the World Wide Web, as an information source has dramatically increased the volume of information that is available to users. Information retrieval from this vast source is often facilitated through a search engine, which may present a large, and often unmanageable, number of information items to a user. Further, once user has access to a particular web site, navigation of the various web pages and other information resources that constitute the web site may be confusing and disorienting. Specifically, the structure of a web site is typically hierarchical, and a user may become disoriented or “lost” within the web site.

Navigation of information may also be required by a user in a number of other instances on an everyday basis. For example, navigation of file directories for data files and programs stored on a local or remote storage medium is a daily activity for most computer users.

### SUMMARY

A system and method for accessing, organizing, and presenting data are described. A first user interface area is presented to enable a user to define a data reference structure for one or more data sources from multiple disparate data sources, the one or more data sources containing data to be provided to the user. A second user interface area is presented to enable the user to create one or more data structures corresponding to the data reference structure and connected to the one or more data sources. A third user interface area is presented to enable the user to define application business logic to be performed on data in connection with the one or more data structures. A fourth user interface area is presented to enable the user to create presentation logic to display data in an output view. Finally, a fifth user interface area is presented to enable the user to define an action that triggers the application business logic.

Other features and advantages of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a block diagram of a conventional network architecture.

FIG. 2 is a block diagram of one embodiment for the network including a system for accessing, organizing, and presenting data.

FIG. 3 is a block diagram of a conventional computer system.

FIG. 4A is a block diagram of an application architecture generated by the system for accessing, organizing, and presenting data.

FIG. 4B is a block diagram of one embodiment for the system for accessing, organizing, and presenting data.

FIG. 5 is a block diagram of one embodiment for a process within the application generated by the system.

FIG. 6 is a flow diagram of one embodiment for a method for accessing and retrieving data from disparate data sources and presenting data to a user.

FIGS. 6A-6C illustrate exemplary diagrams for the method for accessing and retrieving data from disparate data sources and presenting data to a user.

FIG. 7 is a flow diagram of one embodiment for a method for constructing the application within the system for accessing, organizing, and presenting data.

FIG. 8 is a flow diagram of one embodiment for a method for defining the application within the system.

FIGS. 8A-8B illustrate exemplary interfaces to define the application.

FIG. 9 is a flow diagram of one embodiment for a method for defining information access parameters within the application.

FIGS. 9A-9B illustrate exemplary interfaces to define the information access parameters.

FIG. 10 is a flow diagram of one embodiment for a method for creating information logic within the application.

FIGS. 10A-10E illustrate exemplary interfaces to create the information logic.

FIG. 11 is a flow diagram of one embodiment for a method for defining business logic within the application.

FIGS. 11A-11E illustrate exemplary interfaces to define the business logic.

FIG. 12 is a flow diagram of one embodiment for a method for creating presentation logic within the application.

FIG. 12A illustrates an exemplary interface to create the presentation logic.

FIG. 13 is a flow diagram of one embodiment for a method for integrating the application within the system for accessing, organizing, and presenting data.

FIG. 13A illustrates an exemplary interface to integrate the application within the system.

FIG. 14 is a flow diagram of one embodiment for a method for creating a set of components within the application.

FIG. 15 is a flow diagram of one embodiment for a method for creating a source document within the application.

FIGS. 15A-15D illustrate exemplary interfaces to create the source document.

FIG. 16 is a flow diagram of one embodiment for a method for converting the source document from a source format to a target format and presenting the source document to the user.

FIGS. 16A-16F are exemplary interfaces to convert the source document to the target format and to present the source document to the user.

### DETAILED DESCRIPTION

According to embodiments described herein, a system and method for creating a source document and presenting the source document to a user in a target format.

In the following detailed description of embodiments of the invention, reference is made to the accompanying drawings in which like references indicate similar elements, and in which are shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

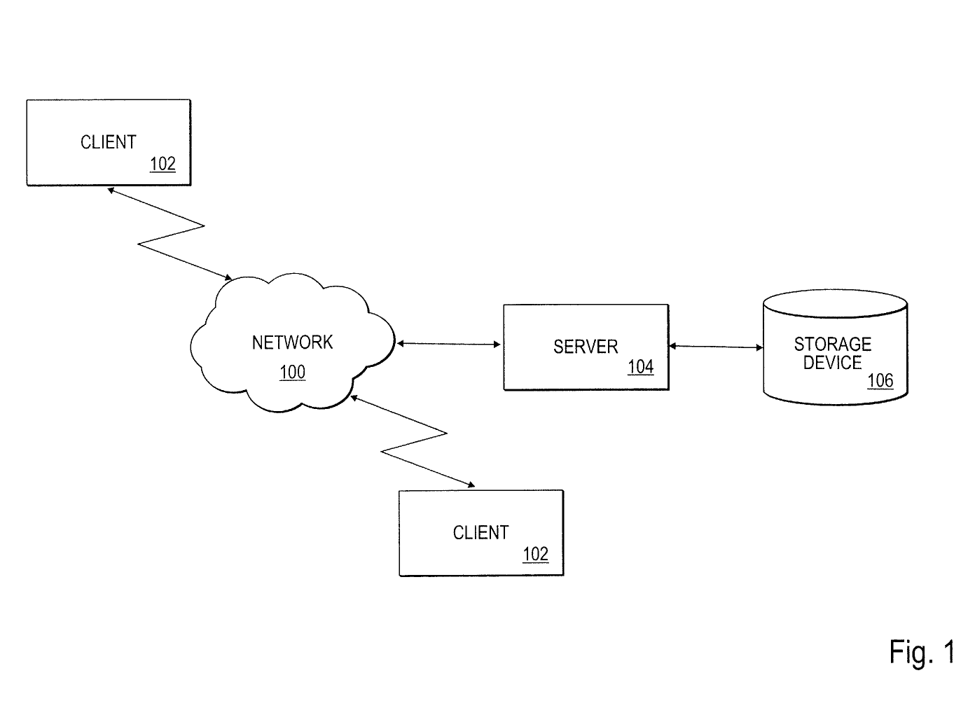

FIG. 1 is a block diagram of a conventional network architecture. Referring to FIG. 1, the block diagram illustrates the network environment in which the present invention operates. In this conventional network architecture, a server computer system 104 is coupled to a network 100, for example a wide-area network (WAN). Wide-area network 100 includes the Internet, specifically the World Wide Web, or other proprietary networks, such as America Online™, CompuServe™, Microsoft Network™, and/or Prodigy™, each of which are well known to those of ordinary skill in the art. Wide-area network 100 may also include conventional network backbones, long-haul telephone lines, Internet service providers, various levels of network routers, and other conventional means for routing data between computers. Using conventional network protocols, server 104 may communicate through wide-area network 100 to a plurality of client computer systems 102, possibly connected through wide-area network 100 in various ways or directly connected to server 104. For example, as shown in FIG. 1, clients 102 are connected directly to wide-area network 100 through direct or dial-up telephone or other network transmission line. Alternatively, clients 102 may be connected to wide-area network 100 through a conventional modem pool (not shown).

Using one of a variety of network connection devices, server computer 104 can also communicate directly with a client 102. In a particular implementation of this network configuration, a server computer 104 may operate as a web server if the World Wide Web (Web) portion of the Internet is used as wide-area network 100. Using the Hyper Text Transfer Protocol (HTTP) and the Hyper Text Markup Language (HTML) across a network, web server 104 may communicate across the Web with client 102. In this configuration, client 102 uses a client application program known as a web browser, such as the Netscape Navigator™ browser, published by America Online™, the Internet Explorer™ browser, published by Microsoft Corporation of Redmond, Wash., the user interface of America Online™, or the web browser or HTML translator of any other supplier. Using such conventional browsers and the Web, client 102 may access graphical and textual data or video, audio, or tactile data provided by server 104. Conventional means exist by which client 102 may supply information to web server 104 through the network 100 and the web server 104 may return processed data to client 102.

Server 104 is further connected to storage device 106. Storage device 106 may be any suitable storage medium, for example read only memory (ROM), random access memory (RAM), EPROMs, EEPROMs, magneto-optical discs, or any other type of medium suitable for storing electronic data.

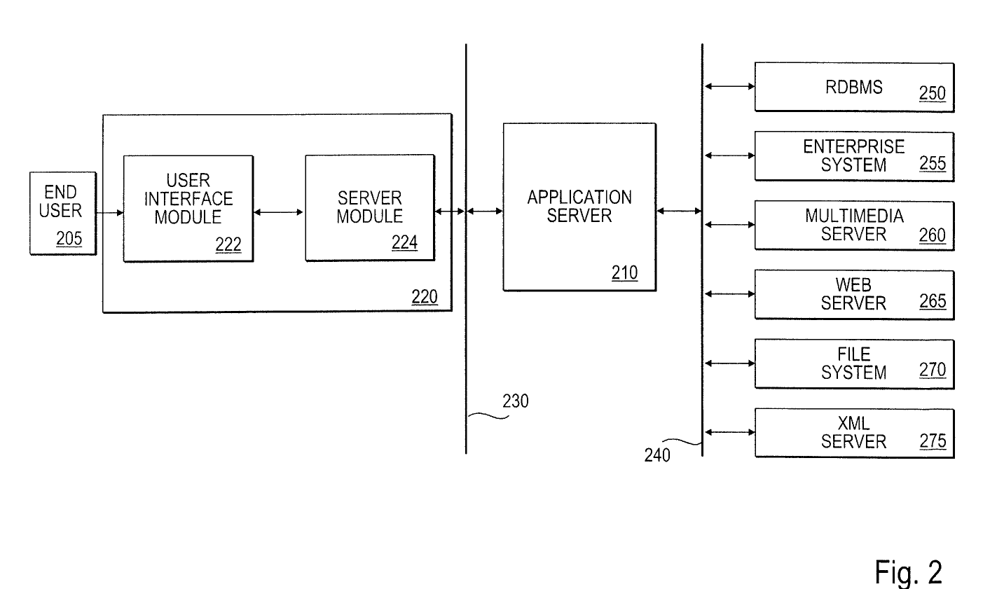

FIG. 2 is a block diagram of one embodiment for the network including a system for accessing, organizing, and presenting data. As illustrated in FIG. 2, in one embodiment, application server 210 is connected to client 220 via bus 230. Alternatively, server 210 may be connected to client 220 via WAN 100. Client 220 further includes a user interface module 222 coupled to a server module 224.

End users, for example end user 205, interact with client 220 via user interface module 222. In one embodiment, end user 205 interacts with the user interface module 222 within client 220 through a browser (not shown) and WAN 100. Alternatively, end user 205 may interact with user interface module 222 directly or through any connection of a number of known types of connections.

In one embodiment, server 210 is also connected to several data sources via bus 240. Alternatively, server 210 may be connected to the data sources via WAN 100. In one embodiment, the data sources may include for example a relational database module (RDBMS) 250, an enterprise system 255, a multimedia server 260, a web server 265, a file system 270, and/or an XML server 275. Alternatively, server 210 may be connected to any of a variety of additional data sources. In one embodiment, the data sources reside in storage device 106. Alternatively, the data sources may reside on disparate storage mediums.

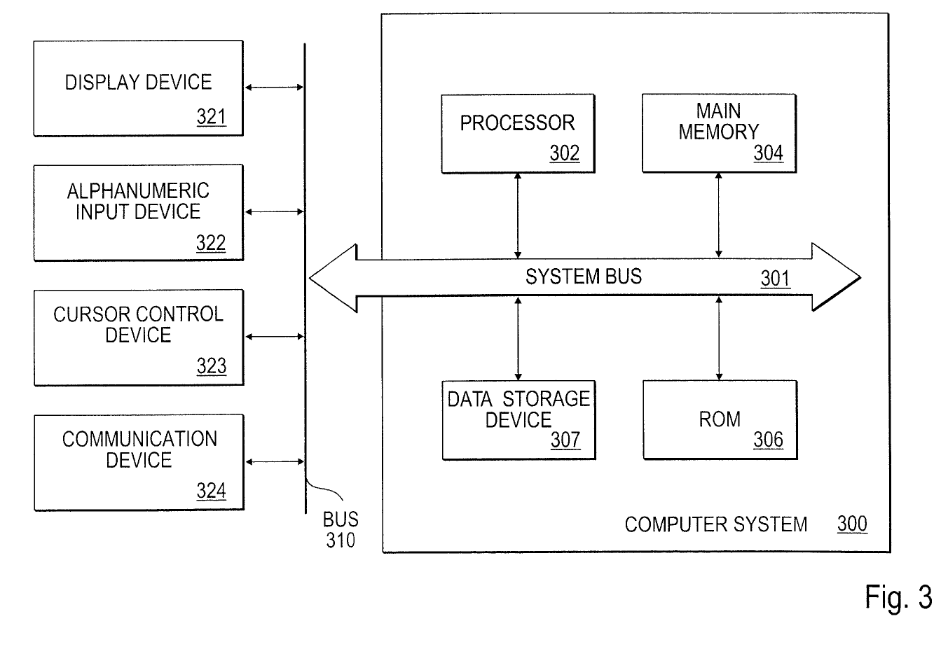

Having briefly described one embodiment of the network environment in which the present invention operates, FIG. 3 shows an example block diagram of a conventional computer system 300 illustrating an exemplary client 102 or server 104 computer system in which the features of the present invention may be implemented.

Computer system 300 includes a system bus 301, or other communications module similar to the system bus, for communicating information, and a processing module, such as processor 302, coupled to bus 301 for processing information. Computer system 300 further includes a main memory 304, such as a random access memory (RAM) or other dynamic storage device, coupled to bus 301, for storing information and instructions to be executed by processor 302. Main memory 304 may also be used for storing temporary variables or other intermediate information during execution of instructions by processor 302.

Computer system 300 also comprises a read only memory (ROM) 306, and/or other similar static storage device, coupled to bus 301, for storing static information and instructions for processor 302.

In one embodiment, an optional data storage device 307, such as a magnetic disk or optical disk, and its corresponding drive, may also be coupled to computer system 300 for storing information and instructions. System bus 301 is coupled to an external bus 310, which connects computer system 300 to other devices. In one embodiment, computer system 300 can be coupled via bus 310 to a display device 321, such as a cathode ray tube (CRT) or a liquid crystal display (LCD), for displaying information to a computer user. For example, graphical or textual information may be presented to the user on display device 321. Typically, an alphanumeric input device 322, such as a keyboard including alphanumeric and other keys, is coupled to bus 310 for communicating information and/or command selections to processor 302. Another type of user input device is cursor control device 323, such as a conventional mouse, touch mouse, trackball, or other type of cursor direction keys, for communicating direction information and command selection to processor 302 and for controlling cursor movement on display 321. In one embodiment, computer system 300 may optionally include video, camera, speakers, sound card, and many other similar conventional options.

Alternatively, the client 102 can be implemented as a network computer or thin client device, such as the WebTV Networks™ Internet terminal or the Oracle™ NC. Client 102 may also be a laptop or palm-top computing device, such as the Palm Pilot™. Such a network computer or thin client device does not necessarily include all of the devices and features of the above-described exemplary computer system. However, the functionality of the present invention may nevertheless be implemented with such devices.

A communication device 324 is also coupled to bus 310 for accessing remote computers or servers, such as server 104, or other servers via the Internet, for example. The communication device 324 may include a modem, a network interface card, or other well-known interface devices, such as those used for interfacing with Ethernet, Token-ring, or other types of networks. In any event, in this manner, the computer system 300 may be coupled to a number of servers 104 via a conventional network infrastructure such as the infrastructure illustrated in FIG. 1 and described above.

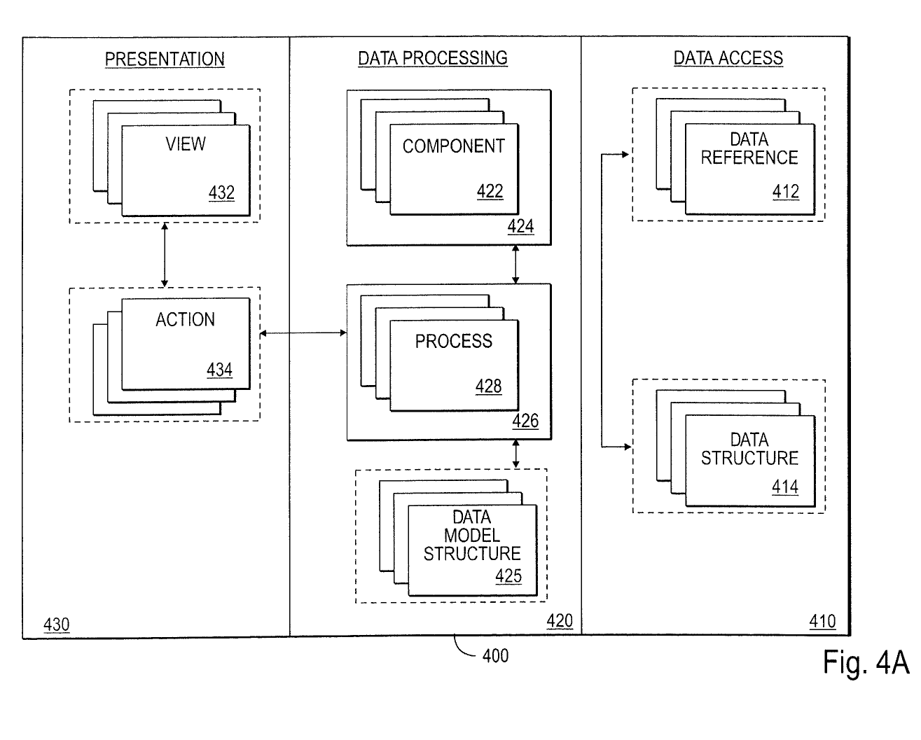

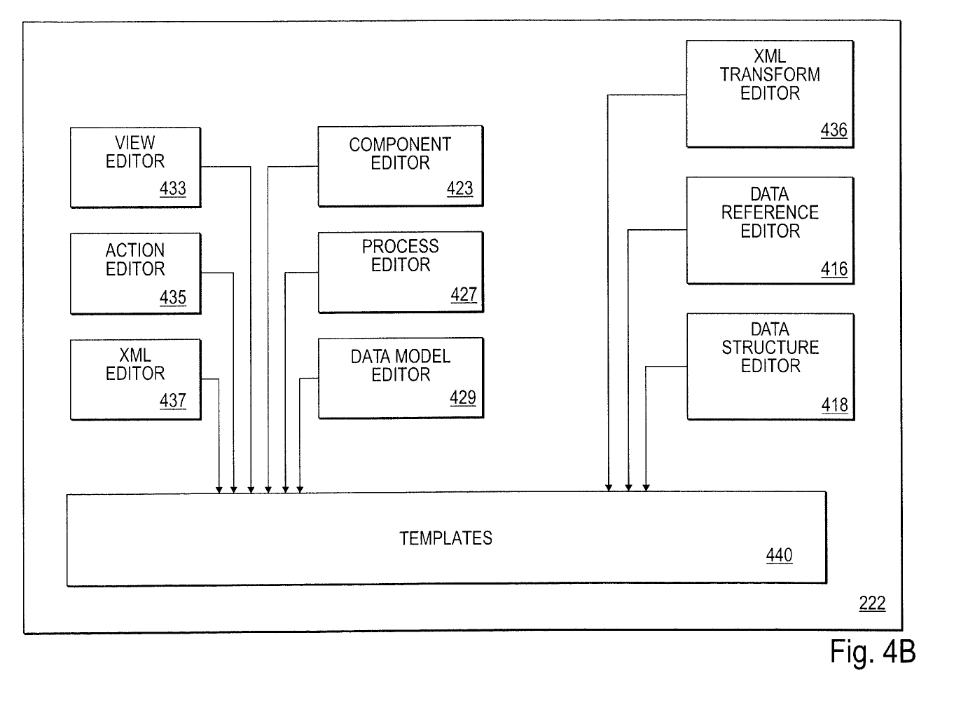

FIG. 4A is a block diagram of an application architecture generated by the system for accessing, organizing, and presenting data. As illustrated in FIG. 4A, application 400 includes a data access layer 410 configured to access and extract data from one or more data sources 250-275, shown in FIG. 2, a data processing layer 420 coupled to the data access layer 410 and configured to process and manipulate data, and a presentation layer 430 coupled to the data processing layer 420 and configured to interact with the processed data and to present one or more views of the processed data to an end user 205.

In one embodiment, the data access layer 410 includes multiple data reference structures 412 which define ways to locate and connect to data within the data sources 250-275, and multiple data structures 414, which are typically based on the data reference structures 412.

In one embodiment, each data reference structure 412 is an object that specifies the source connection information to data. For example, one data reference structure 412 may be defined to access a relational database located locally or on a remote server, such as RDBMS 250 shown in FIG. 2. Alternatively, other data reference structures 412 may be a flat file, a web file, or an XML document, designed to connect to file system 270, web server 265, or XML server 275, respectively. A user 205 may define one or more data reference structures 412 using a data reference editor residing within the user interface module 222.

In one embodiment, each data structure 414 is an object, which refers to one or more data reference structures 412 and which includes metadata that defines the data to be accessed, specifies a set of operations to be performed on the data, and defines logic to be applied when data is retrieved from the accessed data source. Alternatively, some data structures 414, labeled abstract data structures, may be created without a reference to a data reference structure. In one embodiment, the set of operations specified are SQL operations and include operations to query, insert, update, and delete data.

A user 205 may create data structures 414 using a data structure editor residing within the user interface module 222. Once created, each data structure 414 is reusable and may be used by different users 205 to extract data from the data sources 250-275.

Referring back to FIG. 4A, in one embodiment, data processing layer 420 includes multiple components 422 stored in one or more libraries 424. Each component 422 is a reusable logic object that performs a specific task within the data processing layer 420, for example iterations, control flow, counter, and SQL operations, such as query, insert, update, delete. Each component 422 may be stored and accessed through libraries 424, which are dynamically recompiled and reloaded at runtime. A user 205 may create components 422 using a component editor residing within the user interface module 222.

In one embodiment, data processing layer 420 further includes one or more processes 428 stored in a processing module 426. Each process 428 uses predetermined sets of components 422, linked together to process data retrieved from data sources 250-275.

In one embodiment, each process 428 is defined by the corresponding set of components 422, and by a data model structure 425, which defines and stores pieces of data read and written by the process 428. A user 205 may define processes 428 using a process editor residing within the user interface module 222. Processes 428 will be described in further detail below.

In one embodiment, data model structure 425 is visible only to its corresponding process 428 and includes properties that define each data item retrieved from data sources 250-275, for example Input, Output, In-Out, or Static, optionality, and whether each data item is secure or not. Alternatively, each data model structure 425 may be transparent and, as a result, accessible to all processes 428 defined within the processing module 426. In one embodiment, data model structures 425 may be nested and may form a nested structure.

Referring back to FIG. 4A, in one embodiment, presentation layer 430 includes multiple views 432 which allow users 205 to view processed data. In one embodiment, views 432 are Java Server Page USP) views. Each JSP view 432 is a dynamic page, for example an HTML page, which supports event-based input mechanisms and contains special tags interpretable by the server 210. Alternatively, views 432 may be presented in eXtensible Markup Language (XML). In one embodiment, each XML view 432 is an XML document accessible to users 205 via Universal Resource Locators (URLs).

Each view 432 includes a mechanism for triggering an action 434 and sets of data transmitted from the data model structures 425 and formatted for the type of view, for example in JSP or XML formats. In one embodiment, actions 434 reside within presentation layer 430 and provide a linkage between users 205 and processes 428. Each action 434 is coupled to one or more views 432 that can trigger that action. Also, each action 434 is further coupled to a process 428 triggered by the action and to a set of views 434 that must be activated after the process 428 concludes.

FIG. 4B is a block diagram of one embodiment for the system for accessing, organizing, and presenting data. As illustrated in FIG. 4B, the system for accessing, organizing, and presenting data, embodied in user interface module 222, includes a data reference editor 416 to define one or more data reference structures 412 within the data access layer 410 of the application 400 and a data structure editor 418 to create one or more data structures 414 within the data access layer 410.

In one embodiment, user interface module 222 further includes a component editor 423 to create sets of components 422 within the data processing layer 420 of the application 400 and a process editor 427 to define and run processes 428 within the data processing layer 420. A data model editor is further provided within the user interface module 222 to define data model structures 425 for processes 428.

In one embodiment, user interface module 222 further includes a view editor 433 to create one or more views 432 within the presentation layer 430 of the application 400 and an action editor 435 to define actions 434 within the presentation layer 430. In one embodiment, an XML editor 437 is provided within user interface module 222 to create views 432 presented in XML format and an XML transform editor 436 is further provided to convert documents created in a source format from a source Document Type Definition (DTD), for example XML, to a target DTD, for example HTML, and to present the document to users in the target format defined by the target DTD.

In one embodiment, user interface module 222 further includes templates 440. The editors within user interface module 222 use templates 440 to create or define corresponding structures for the application 400.

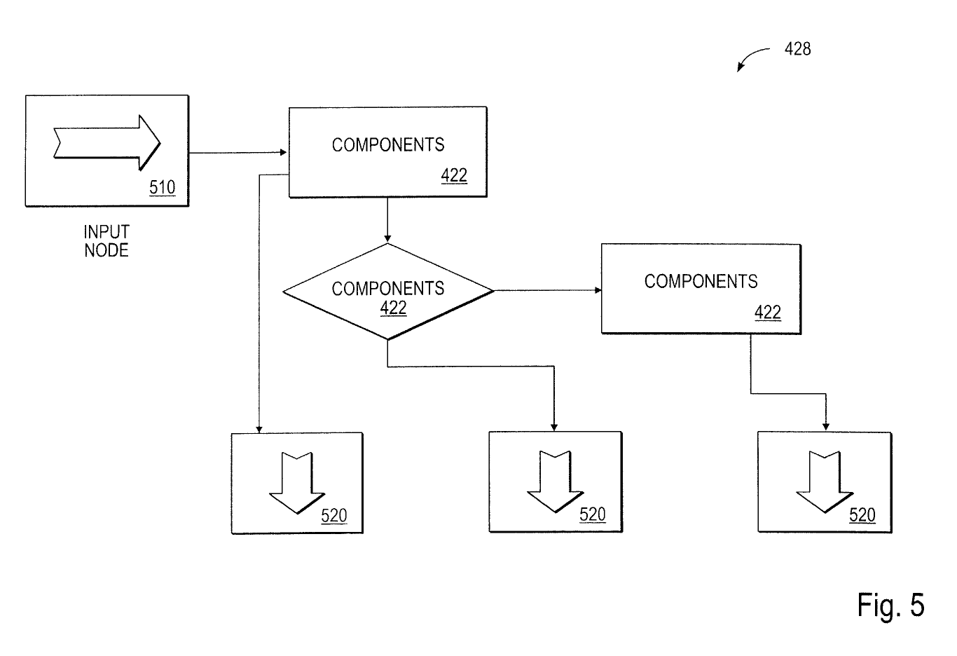

FIG. 5 is a block diagram of one embodiment for a process within the application generated by the system. As illustrated in FIG. 5, a process 428 includes an input node or process request 510, which receives multiple input parameters from user 205 through one or more views 432. Input node 510 is coupled to one or more components 422, which contain the logic of the process 428 and perform specific logic tasks. Each component 422 has a single point of entry and produces a set of responses 520. Each response 520 represents a result of process 428 and is returned to an action 434 that invoked the process 428. In one embodiment, the action 434 that triggered the process 428 associates each response 520 to a view 432 to be transmitted back to user 205.

Processes 428 can be linked by mapping a response 520 of one process 428 to an input node 510 of another process 428. Processes 428 may also be nested, wherein one process 428 may operate within another process 428.

In one embodiment, one or more data model structures 425 are defined for each process 428. The input parameters received at the input node 510 and output parameters within responses 520 are mapped to the data model structures 425 to provide data persistence for the duration of the execution of the process 428.

In one embodiment, components 422 are standard for each process 428. For example, condition components provide binary decision processing, process data components define operations to be performed on data sources, and iteration components provide data fetching and simplify the configuration of process 428. Alternatively, components 422 may be custom created for each process 428 by defining the corresponding data model structures 425 and the set of responses 520.

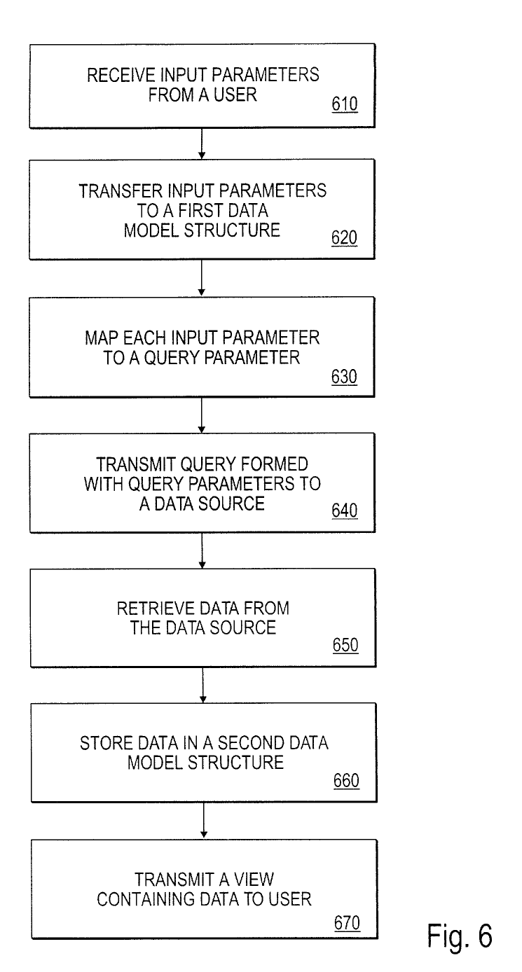

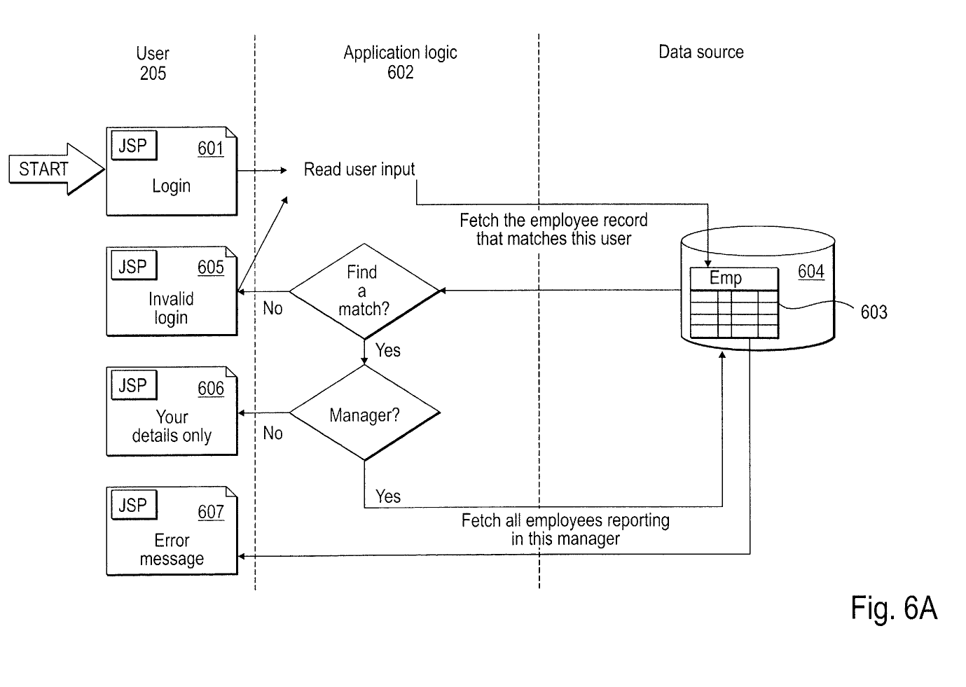

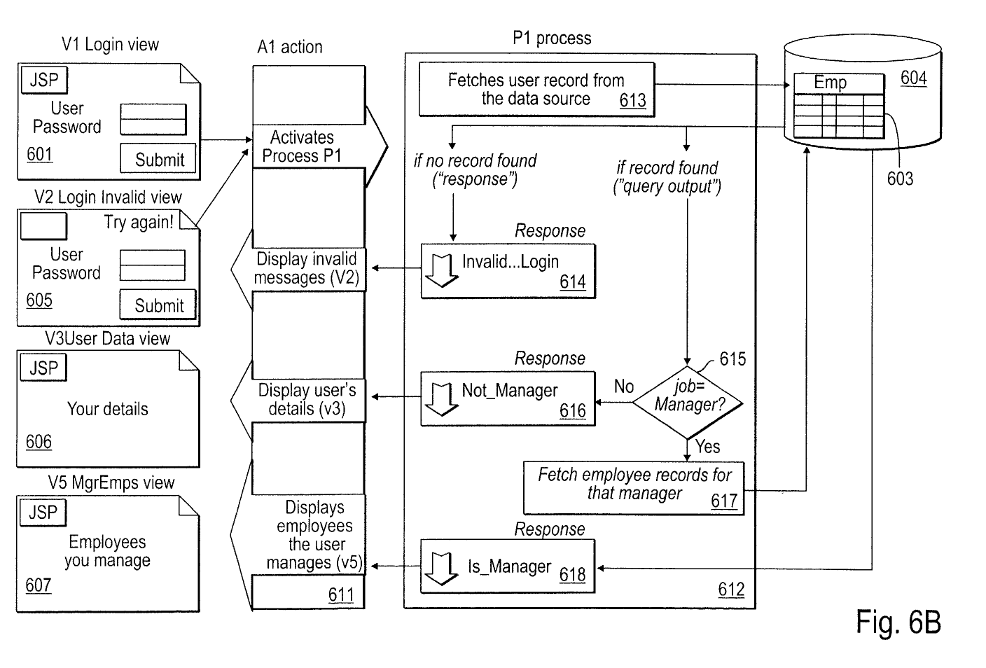

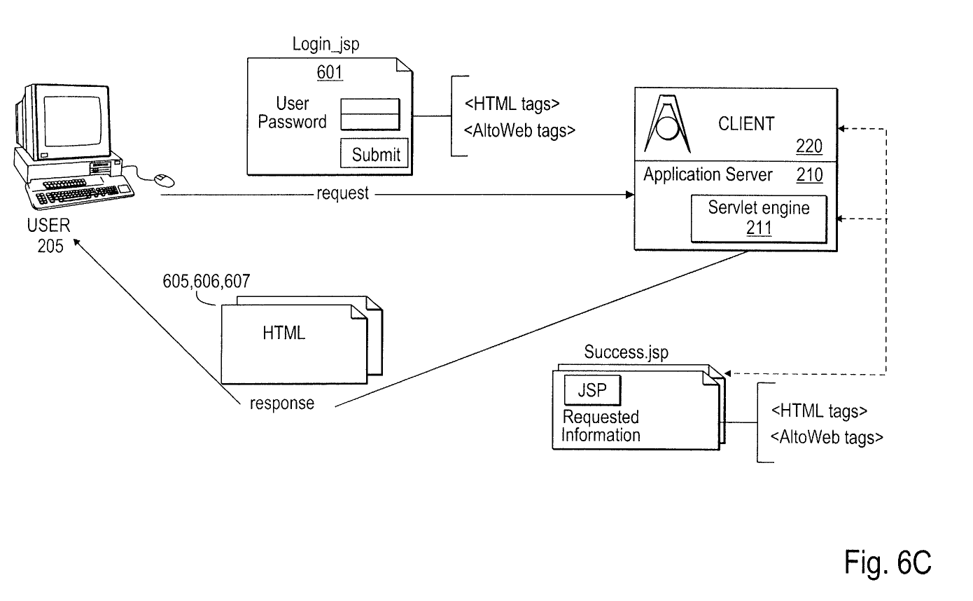

FIG. 6 is a flow diagram of one embodiment for a method for accessing and retrieving data from disparate data sources and presenting data to a user. As illustrated in FIG. 6, at processing block 610, input parameters are received from a user 205. In one embodiment, user 205 inputs the input parameters in an input view 432 displayed on a user browser and transmits the input parameters to the user interface module 222. The view 432 triggers an action 434 within the presentation layer 430 of the application 400. In one embodiment, the action 434 further activates a process 428 within the data processing layer 420 of the application 400.

At processing block 620, input parameters are transferred to a first data model structure 425, for example a process data model structure 425, within the data processing layer 420 of application 400. In one embodiment, the first data model structure 425 can only be accessed by the corresponding active process 428.

At processing block 630, each input parameter in the process data model structure 425 is mapped to a query parameter in a pre-defined data structure 414 within the data access layer 410 of the application 400. In one embodiment, a standard component 422, or set of components 422, performing tasks within process 428 maps the input parameters to the query parameters of the data structure 414. In one embodiment, data structure 414 is not a part of the process 428.

At processing block 640, a query formed with the mapped query parameters is transmitted to a data source. In one embodiment, the data structure 414 within data access layer 410 has an associated data reference structure 412 that specifies how to access the data stored within a data source 250-275. In one embodiment, the data reference structure 412 resides within the data access layer of the application 400 and is not part of the process 428.

At processing block 650, data is retrieved from the data source. In one embodiment, the data structure 414 retrieves data from data sources 250-275 using information from the data reference structure 412.

At processing block 660, data is stored in a second data model structure 425, for example a project data model structure 425. In one embodiment, data structure 414 stores the data retrieved from the data source into the project data model structure 425. In one embodiment, the project data model structure 425 is transparent and is visible to the entire application 400.

Finally, at processing block 670, a view containing the stored data is transmitted to the user. In one embodiment, process 428 returns one response 520 of the set of available responses 520. Action 434 associates the response 520 with an output view 432 created within the presentation layer 430, which reads the data from the second data model structure 425 and displays it to user 205.

FIGS. 6A-6C illustrate exemplary diagrams for the method for accessing and retrieving data from disparate data sources and presenting data to a user. In one embodiment, user 205 interacts with an application 602 via the user browser and the user interface module 222.

As illustrated in FIG. 6A, user 205 enters input information, for example login information, in an input view 601 and transmits the information to the user interface module 222 within client 220. In one embodiment, input view 601 is a JSP view, which enables dynamic data to be displayed on pages created in a specific language, for example Hyper Text Markup Language (HTML).

In one embodiment, application 602 performs several tasks to verify the login information against data stored in a table 603 within a data source 604, for example a database. Data stored in table 603 includes employee records and other information.

In one embodiment, based on the tasks performed by application 602, user 205 receives different responses, for example different output views 605607. In one embodiment, output views 605-607 are JSP views.

In one embodiment, if application 602 cannot match the login information with any data within table 603, application 602 communicates to user 205 that the login information is not valid in output view 605, which displays a message informing user 205 that the login information is invalid. If application 602 matches the login information with an employee record within the stored data, but cannot identify user 205 as a manager, application 602 retrieves data related to user 205 and communicates data to user 205 in output view 606. If application 602 matches the login information with an employee record within the stored data and determines that user 205 is a manager, application 602 retrieves data related to user 205 and data related to employees managed by user 205 and communicates data to user 205 in output view 607.

As illustrated in FIG. 6B, input view 601 containing input parameters from user 205, for example input login information, triggers an action 611 associated with view 601. In one embodiment, action 611 activates a process 612 within application 602.

In one embodiment, at processing block 613, process 612 accepts the input parameters and submits a query to the data source 604 to retrieve an employee record matching the input login information submitted by user 205. If no match is found, process 612 returns response 614 showing invalid login information.

Otherwise, if a match is found, at decision block 615, process 612 processes the employee record and determines if user 205 is a manager. If user 205 is not a manager, process 612 returns response 616 containing the employee record.

Otherwise, if process 612 determines that user 205 is a manager, at processing block 617, process 612 submits a query to the data source 604 to retrieve data related to employees managed by user 205. Then, process 612 returns response 618 containing the employee record and data related to the other employees.

In one embodiment, action 611 displays the appropriate response 614, 616, or 618 in respective output views 605, 606, 607 based on the response returned by the process 612.

As illustrated in FIG. 6C, in one embodiment, the views displayed to the user 205 are JSP views, which use HTML and Java server-side technology to create dynamic, interactive pages. In one embodiment, user 205 submits a request across network 100 using input view 601 containing input parameters. Application server 210 receives the request and passes details of the action 611 specified within input view 601 to client 220.

Client 220 executes the process 612 activated by action 611, and determines a response 614, 616, or 618 that needs to be returned to the user 205 within an output view 605-607. Application server 210 compiles the response in the output view 605-607 and creates a servlet using a servlet engine 211.

For each tag in the output view 605-607, application server 210 requests information from client 220. Finally, when all tags have been identified and resolved, the servlet sends the corresponding output view 605-607 in HTML format to user 205.

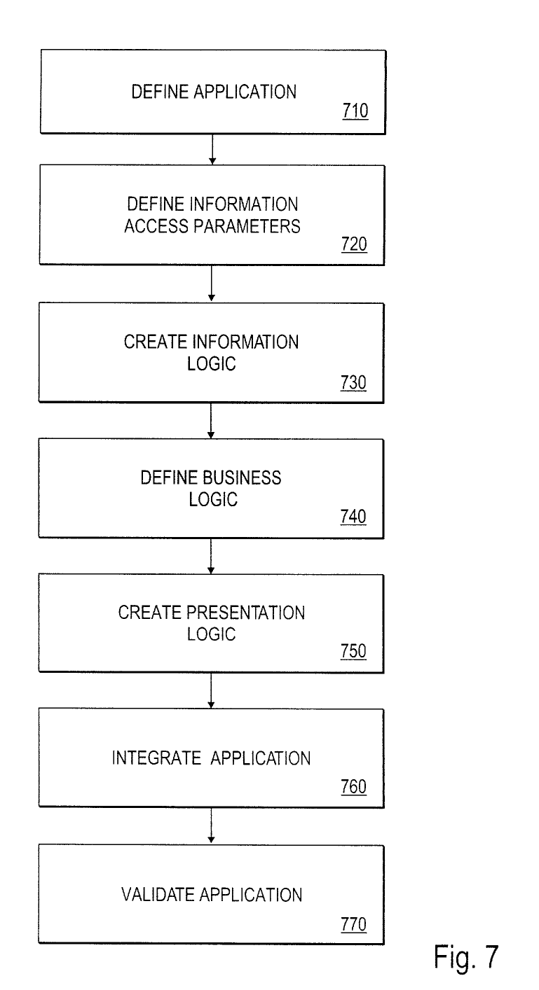

FIG. 7 is a flow diagram of one embodiment for a method for constructing the application within the system for accessing, organizing, and presenting data. As illustrated in FIG. 7, at processing block 710, an application is defined, the application being configured to access and retrieve data from disparate data sources and to present data to a user. In one embodiment, end user 205 accesses the user interface module 222 within client 220 to define a new application. The process of defining an application will be described in further detail below.

At processing block 720, information access parameters are defined for the application. In one embodiment, end user 205 accesses the user interface module 222 within client 220 to define information access parameters, for example data reference structures 412, configured to specify connection information to data stored within data sources 250-275. In one embodiment, end user 205 interacts with the data reference editor 416 within user interface module 222 to define the data reference structures 412. The process of defining data reference structures 412 will be described in further detail below.

At processing block 730, information logic is created for the application. In one embodiment, end user 205 accesses the user interface module 222 within client 220 to create information logic, for example data structures 414 configured to identify data within data sources 250-275, to perform a set of predetermined operations on data, and to apply logic after data is retrieved. In one embodiment, end user 205 also defines relationships among the created data structures 414. End user 205 interacts with the data structure editor 418 within user interface module 222 to create the data structures 414. The process of creating information logic will be described in further detail below.

At processing block 740, business logic is defined for the application. In one embodiment, end user 205 accesses the user interface module 222 within client 220 to define a process 428 configured to receive input parameters and to perform read and write operations on data within the defined application, one or more data model structures 425 that define and store the data read and written by process 428, and a set of components 422 containing the logic of process 428. In one embodiment, end user 205 interacts with the component editor 423, the process editor 427, and the data model editor 429 within user interface module 222 to define components 422, process 428, and data model structures 425 respectively. The process of defining business logic will be described in further detail below.

At processing block 750, presentation logic is created for the application. In one embodiment, end user 205 accesses the user interface module 222 within client 220 to create presentation views 432, for example input views, which include input parameters provided by end user 205, and output views, which include processed data retrieved from data sources 250-275 and displayed to user 205. In one embodiment, end user 205 interacts with view editor 433 within user interface module 222 to create views 432. The process of creating presentation logic will be described in further detail below.

At processing block 760, the application is integrated. In one embodiment, end user 205 accesses the user interface module 222 within client 220 to define an action 434 which triggers the process 428, and to connect the action 434 to both input and output views 432. In one embodiment, end user 205 interacts with action editor 435 within user interface module 222 to define action 434. The process of integrating the application will be described in further detail below. Finally, at processing block 770, the application is validated.

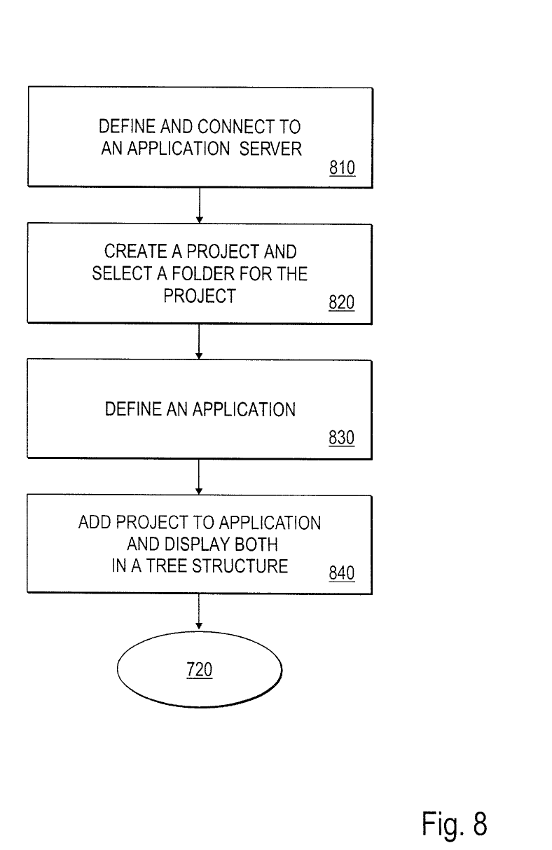

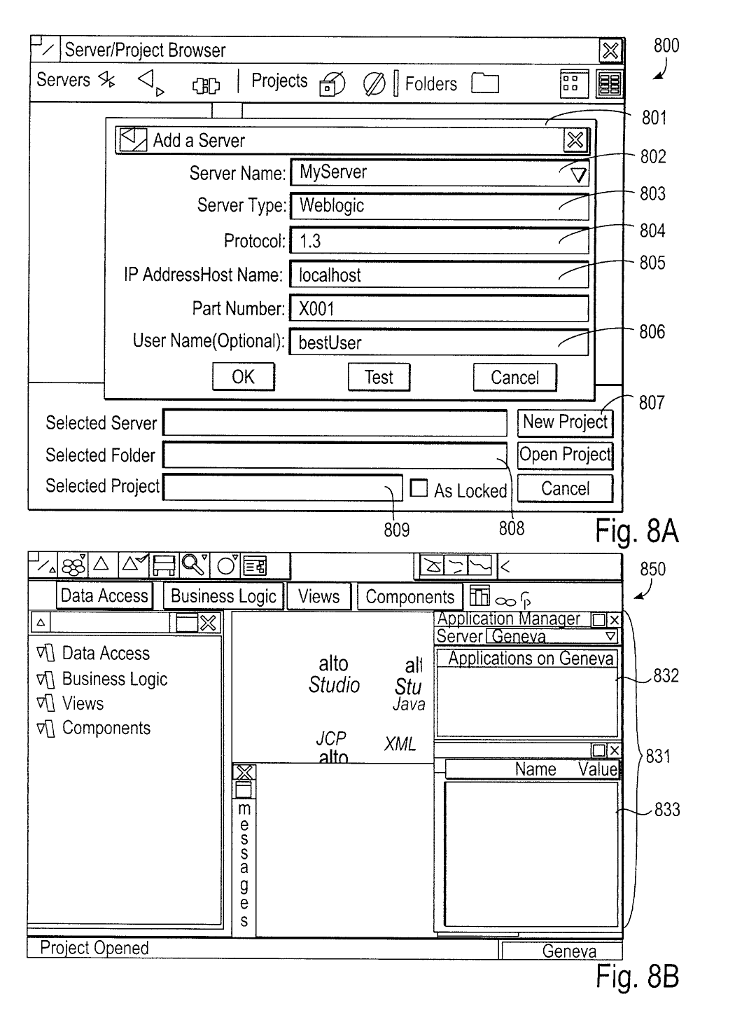

FIG. 8 is a flow diagram of one embodiment for a method for defining the application within the system. FIGS. 8A-8B illustrate exemplary interfaces to define the application.

As illustrated in FIG. 8, at processing block 810, an application server is defined and a connection is established with the application server. In one embodiment, user 205 defines application server 210 through the user interface module 222 within client 220.

Referring to FIG. 8A, interface 800 displays a dialog box 801, which includes multiple fields for defining the application server 210. In one embodiment, user 205 identifies the application server 210 in a Server Name field 802, identifies the type of server in a Server Type field 803, provides a connection mechanism associated with the application server 210 in a Protocol field 804, for example a message protocol supported by the application server 210, provides the name or a network address for the application server 210 in a IP Address/Host Name field 805, for example an Internet Protocol (IP) address, and a user name designating a default identification field to be used in future connections with the application server 210 in a User Name field 806. Finally, user 205 submits the information by pressing a button within the dialog box 801 with a conventional mouse click.

Subsequent to defining the application server 210, user 205 transmits a connection request to application server 210 through the user interface module 222. In one embodiment, server module 224 within client 220 receives the request and communicates with application server 210 to establish the requested connection.

As illustrated in FIG. 8, at processing block 820, a project is created and a folder is selected for the project. In one embodiment, user 205 creates the project and selects a folder for the project through the user interface module 222 within client 220.

Referring to FIG. 8A, in one embodiment, interface 800 further includes a New Project interactive button 807 and a Selected Project field 808 for creating the project, and a Selected Folder field 809 for selecting the folder for the project. In one embodiment, user 205 inputs a name for the folder in the Selected Folder field 809. Then, user 205 specifies the name of the new project in the Selected Project field 808 and presses the New Project button 807 with a conventional mouse click. In one embodiment, if the specified folder does not exist, a new folder will be created for the new project. Alternatively, if user 205 specifies the name of an already existent folder, the project is created and stored in the existent folder.

As illustrated in FIG. 8, at processing block 830, the application configured to include the project is defined. In one embodiment, user 205 defines the application through the user interface module 222 within client 220.

Referring to FIG. 8B, interface 850 includes an Application Manager window 831, which displays applications defined within client 220 in a hierarchical node structure. In one embodiment, user 205 selects a top node 832 within the node structure of window 831 with a mouse click. Then, user 205 chooses an Add New Application field (not shown) from a menu obtained using a mouse right-click command. Next, in one embodiment, in Properties box 833 within the Application Manager window 831, user 205 inputs a name for the new application. The name of the newly defined application will appear as an application node in the node structure displayed within Application Manager 831.

As illustrated in FIG. 8, at processing block 840, the project created above is added to the application and both are displayed in a tree structure. In one embodiment, user 205 adds the project to the application through the user interface module 222 within client 220.

Referring to FIG. 8B, in one embodiment, user 205 selects the new application node within the node structure of window 831 and chooses an Add Project field (not shown) from a menu displayed by a mouse right-click command. Next, a Project Property Editor window is displayed and user 205 selects the project name from a Select Project drop list within the Project Property Editor window. Subsequently, user interface module 222 displays for the user 205 a structure, for example a hierarchical tree structure, containing the application associated with application server 210 as a root node of the tree structure, and the project as a child node connected to the root node within the tree structure.

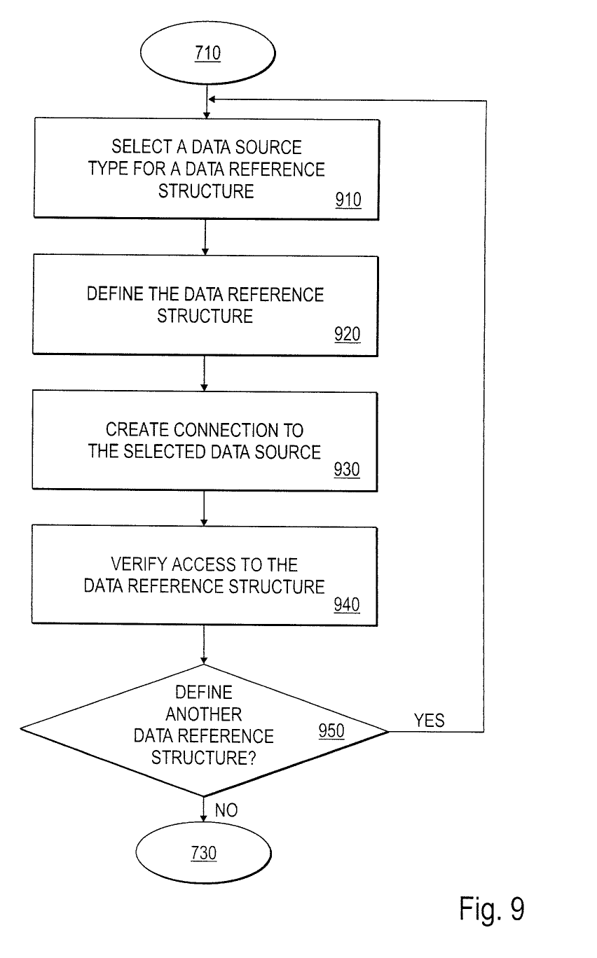

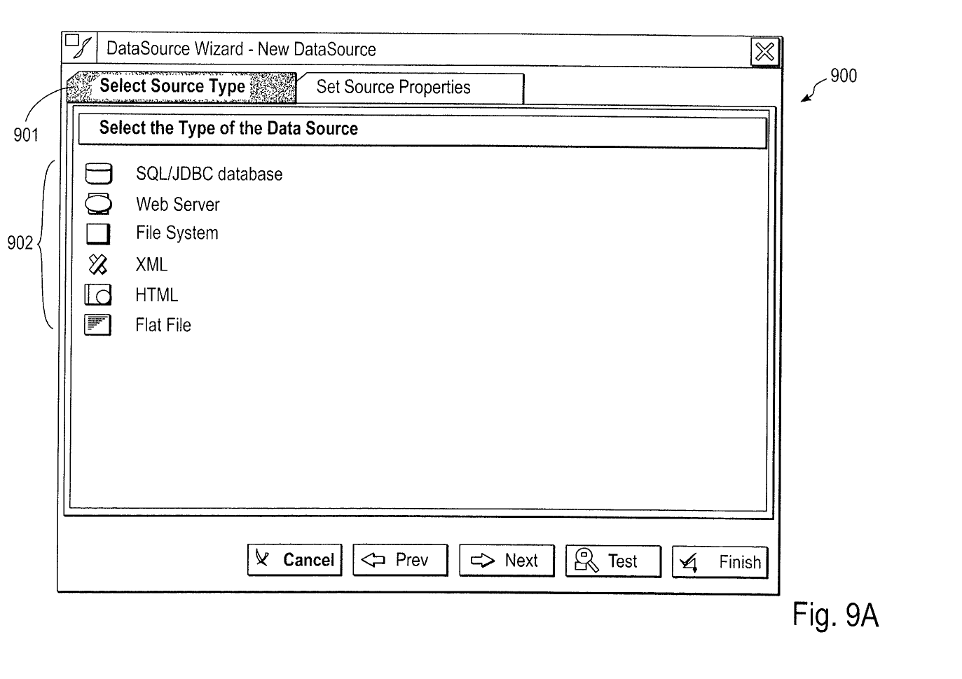

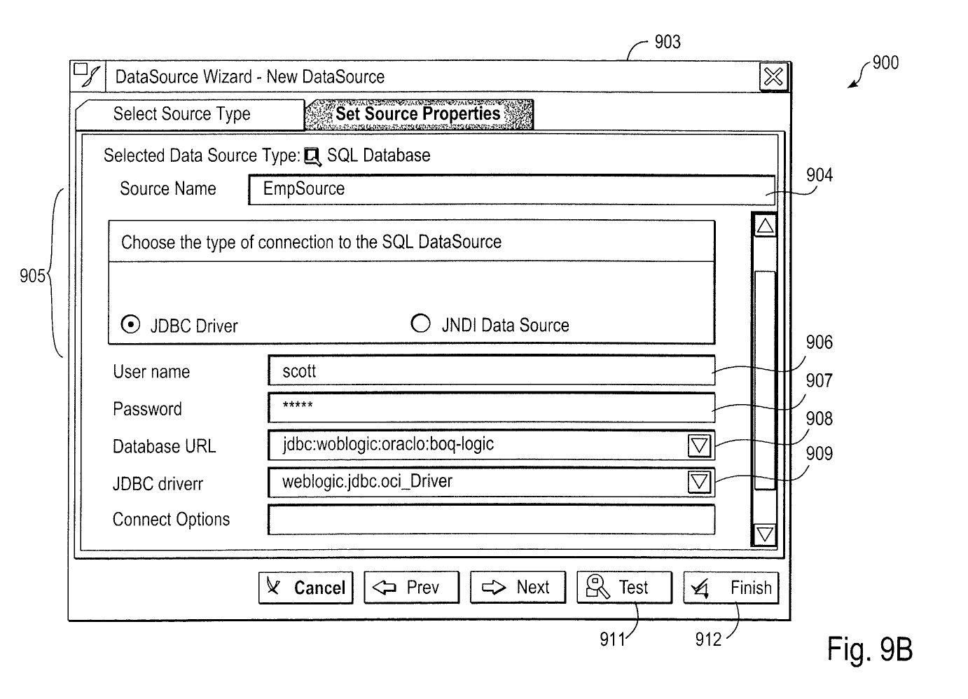

FIG. 9 is a flow diagram of one embodiment for a method for defining information access parameters within the application. FIGS. 9A-9B illustrate exemplary interfaces to define the information access parameters.

As illustrated in FIG. 9, at processing block 910, a data source type is selected for a data reference structure to be defined. In one embodiment, user 205 selects the data source type for the data reference structure 412 through data reference editor 416 within user interface module 222.

Referring to FIG. 9A, in one embodiment, user 205 selects a Select Source Type tab 901 within a first user interface area, for example interface 900, with a conventional mouse click. Interface 900 displays a list 902 of available data source types for data sources 250-275. In one embodiment, list 902 contains a SQL/JDBC database type, a Web Server type, a File System type, an XML type, an HTML type, and a Flat File type. It is to be understood that other types of data sources may be included in list 902. Next, user 205 selects a type of data source from the list 902, for example the SQL/JDBC database.

As illustrated in FIG. 9, at processing block 920, the data reference structure is defined. In one embodiment, user 205 defines the data reference structure 412 through data reference editor 416 within user interface module 222.

Referring to FIG. 9B, in one embodiment, user 205 selects a Set Source Properties tab 903 within interface 900 using a conventional mouse click command. Interface 900 displays multiple fields to allow user 205 to define the data reference structure 412.

In one embodiment, user 205 inputs a name for the data reference structure 412 in a Source Name field 904 and chooses a type of connection to the selected data source in window 905 using a conventional mouse click command. For example user 205 selects the JDBC driver option within window 905.

As illustrated in FIG. 9, at processing block 930, a connection is created to the selected data source. In one embodiment, user 205 creates the connection to the data source 250-275 through data reference editor 416 within user interface module 222.

Referring to FIG. 9B, in one embodiment, user 205 interacts with interface 900 and inputs login information, such as a user name in the User Name field 906 and a password in the Password field 907. Then, user 205 selects a database URL from a drop-down menu displayed upon a mouse click request in the Database URL field 908.

Subsequently, user 205 inputs information regarding the type of connection selected in a JDBC Driver field 909 using a drop-down menu displayed upon a mouse click request. In one embodiment, user 205 inputs the selected JDBC driver information in field 909.

As illustrated in FIG. 9, at processing block 940, access to the data reference structure and the connection to the data source are verified. In one embodiment, user 205 verifies access to the data reference structure 412 and the connection to the data source through data reference editor 416 within user interface module 222.

Referring to FIG. 9B, in one embodiment, user 205 presses a Test button 911 within interface 900 with a mouse click to verify access to the data reference structure 412. Then, user 205 presses the Finish button 912 within interface 900 to exit the process.

As illustrated in FIG. 9, at processing block 950, a decision is made whether another data reference structure needs to be defined. If user 205 needs to access another data source 250-275, then another data reference structure 412 needs to be defined for the specific data source and processing blocks 910 through 940 are repeated. In one embodiment, user 205 repeats the steps associated with processing blocks 910-940 and communicates with data reference editor 416 to create the new data reference structure 412. Otherwise, if no other data reference structure 412 needs to be defined, the procedure continues with the creation of information logic.

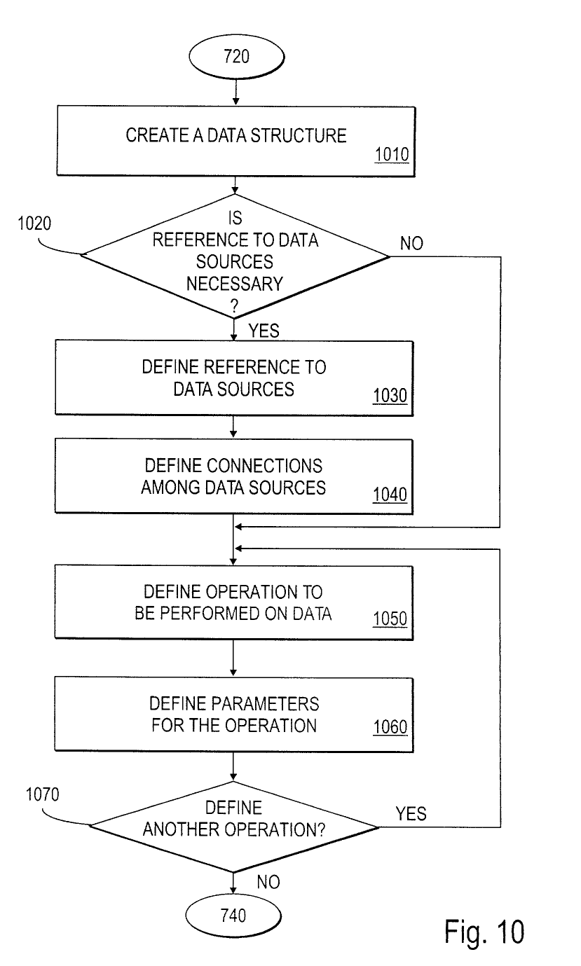

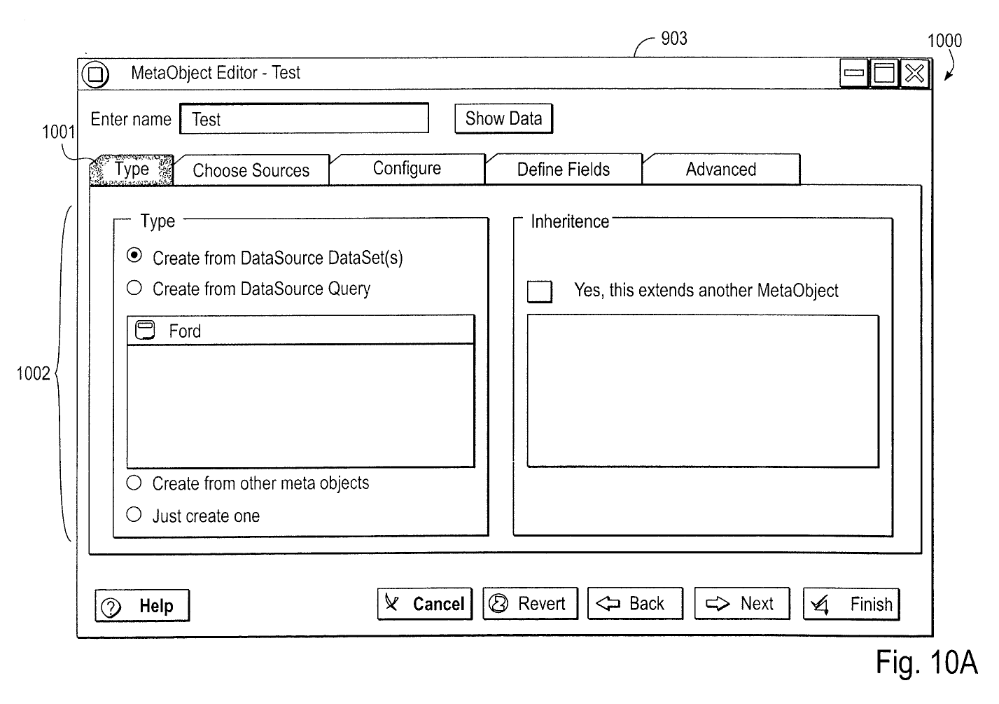

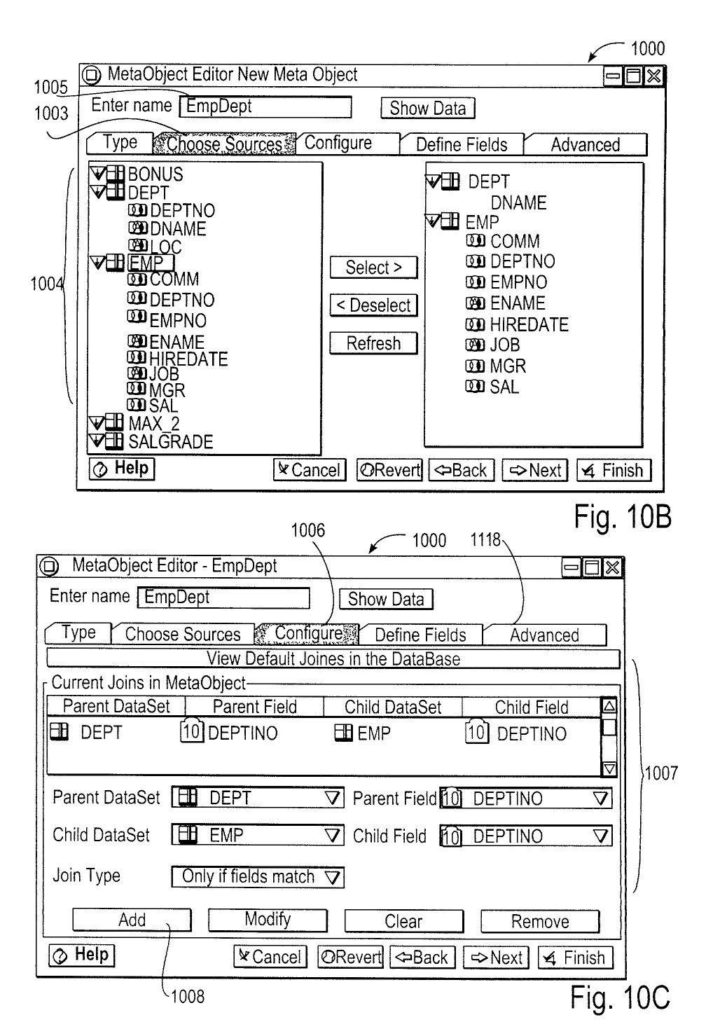

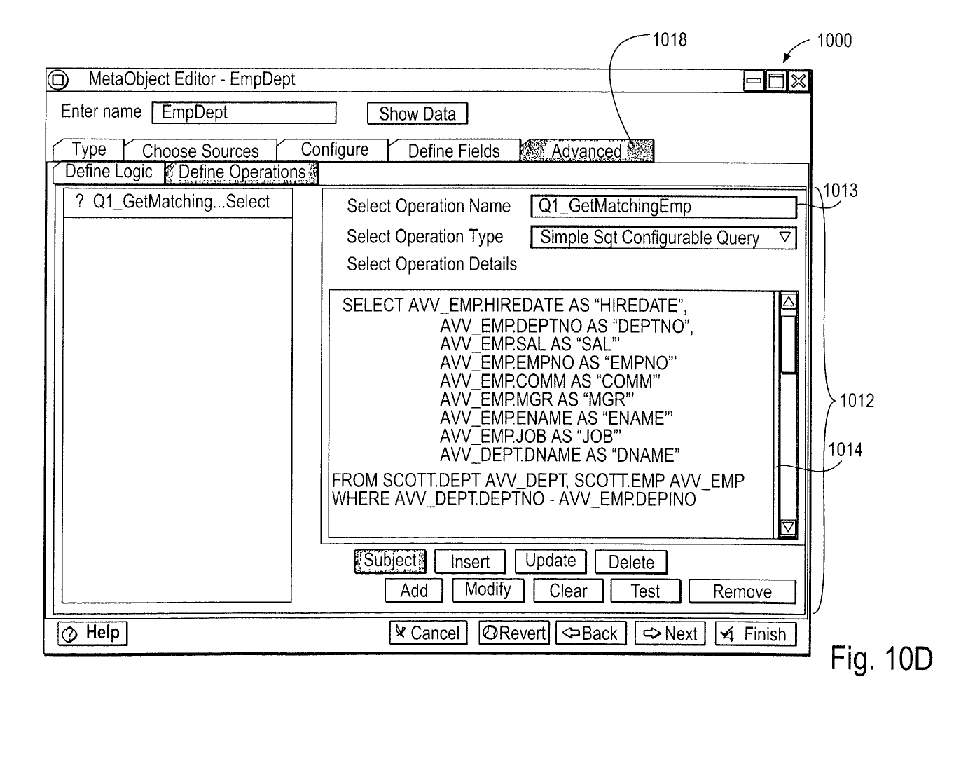

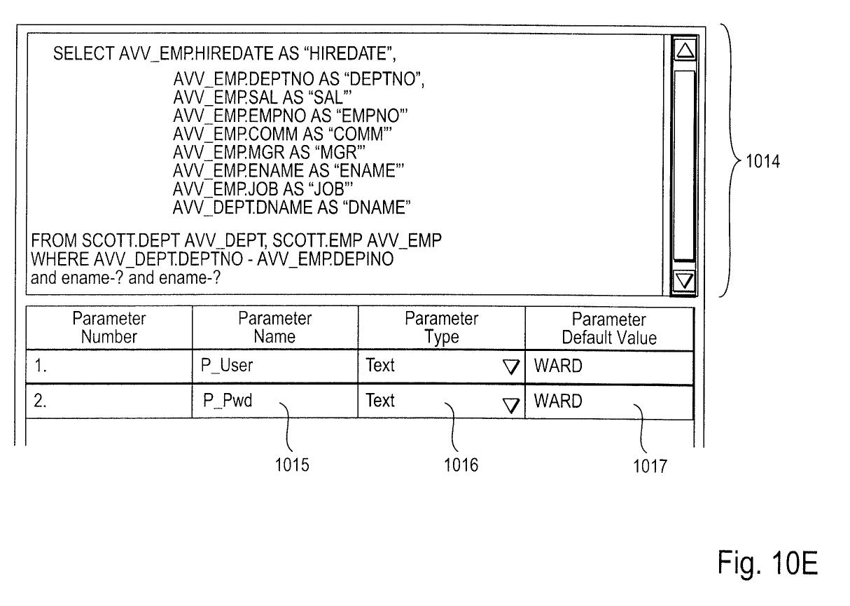

FIG. 10 is a flow diagram of one embodiment for a method for creating information logic within the application. FIGS. 10A-10E illustrate exemplary interfaces to create the information logic.

As illustrated in FIG. 10, at processing block 1010, a data structure is created. In one embodiment, user 205 creates a data structure 414 through data structure editor 418 within user interface module 222.

Referring to FIG. 10A, in one embodiment, user 205 selects a Type tab 1001 within a second interface area, for example interface 1000, with a conventional mouse click. Interface 1000 displays a window 1002 allowing selection of a data structure type for the data structure 414. Then, user 205 selects one option within window 1002 using a mouse click command. In one embodiment, user 205 selects the Create from Data Source Dataset(s) option within window 1002.

Referring to FIG. 10B, in one embodiment, user 205 selects a Choose Sources tab 1003 within interface 1000 with a conventional mouse click. Interface 1000 displays a window 1004 containing a list of data sources accessible through user interface module 222. In one embodiment, user 205 enters a name for the data structure 414 in a field 1005 within interface 1000.

As illustrated in FIG. 10, at processing block 1020, a decision is made whether a reference to the data sources is necessary within the data structure 414. If a reference to the corresponding data sources 250-275 is not necessary, the procedure jumps to processing block 1050. Otherwise, if a reference to data sources is necessary, at processing block 1030, the reference to the data sources is defined. In one embodiment, user 205 defines a reference link, which illustrates a reference to the data sources, through data structure editor 418 within user interface module 222.

Referring to FIG. 10B, in one embodiment, user 205 selects one or more data sources 250-275 from the list of data sources displayed within window 1004. Using a conventional mouse click command, user 205 presses a Select button within window 1004 to define a reference link to each selected data source 250-275.

As illustrated in FIG. 10, at processing block 1040, connections among the selected data sources are defined. In one embodiment, user 205 defines the connections among the data sources through data structure editor 418 within user interface module 222.

Referring to FIG. 10C, in one embodiment, user 205 selects a Configure tab 1006 within interface 1000 with a mouse click. Interface 1000 displays multiple fields to allow user 205 to define the connections among the selected data sources 250-275.

In one embodiment, user 205 selects the connections from data structure connection fields 1007 displayed within interface 1000. In one embodiment, the data structure connection fields 1007 are drop-down lists accessible through mouse click commands and containing alternative connections among the selected data sources. Subsequently, user 205 presses an Add button 1008 within interface 1000 to connect the selected data sources 250-275.

As illustrated in FIG. 10, at processing block 1050, an operation to be performed on data stored within the selected data sources is defined. In one embodiment, user 205 defines the operation to be performed on data through data structure editor 418 within user interface module 222.

Referring to FIG. 10D, in one embodiment, user 205 selects an Advanced tab 1018 within interface 1000 with a mouse click. Further, user 205 selects a Define Operations tab 1011 within interface 1000. In one embodiment, interface 1000 displays a window 1012 containing multiple fields, which allow user 205 to define an operation to be performed on the data, for example a query to retrieve data stored in the selected data sources 250-275.

In one embodiment, user 205 inputs a name for the defined operation in a Select Operation Name field 1013 within window 1012. Next, user 205 selects an operation type from a drop-down list within window 1012 using a conventional mouse click command. Interface 1000 displays a statement for the selected operation in a Select Operation Details field 1014 within window 1012.

As illustrated in FIG. 10, at processing block 1060, parameters are defined for the selected operation. In one embodiment, user 205 defines one or more parameters, for example query parameters, for the selected operation or query through data structure editor 418 within user interface module 222.

Referring to FIG. 10E, in one embodiment, user 205 appends language designed to define the query parameters within the statement displayed in field 1014. As a result, interface 1000 displays multiple parameter fields to allow user 205 to define each query parameter of the requested parameters for the selected query.

In one embodiment, user 205 inputs the name of the defined parameters in a Parameter Name field 1015 and chooses a parameter type for each defined parameter from a drop-down list displayed within a Parameter Type field 1016. Finally, user 205 inputs a default value for each defined parameter in a Parameter Default Value field 1017.

As illustrated in FIG. 10, at processing block 1070, a decision is made whether to define another operation within data structure 414. If another operation needs to be defined within the data structure 414, processing blocks 1050 through 1060 are repeated. In one embodiment, user 205 repeats the steps associated with processing blocks 1050, 1060 and communicates with data structure editor 418 within user interface module 222 to define another operation. Otherwise, if no other operation needs to be defined, the procedure continues with the definition of business logic.

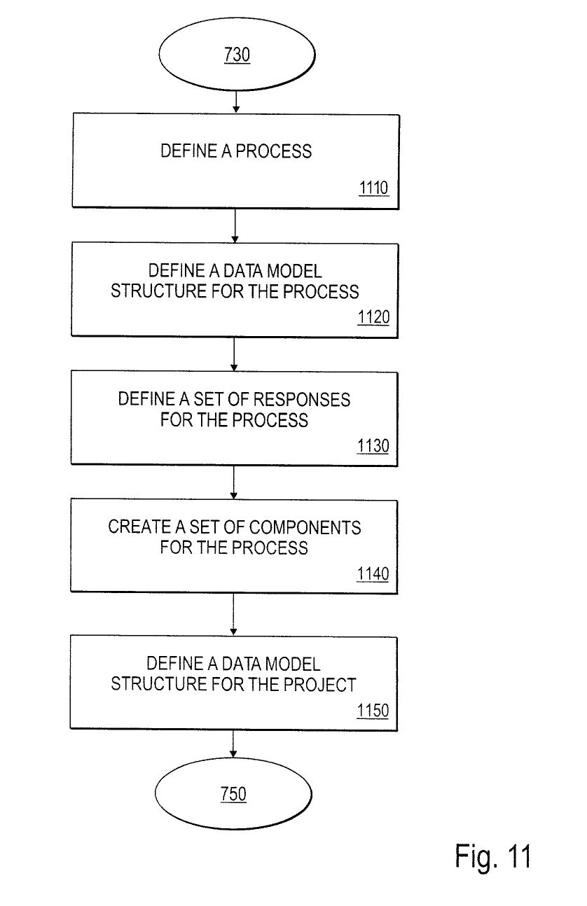

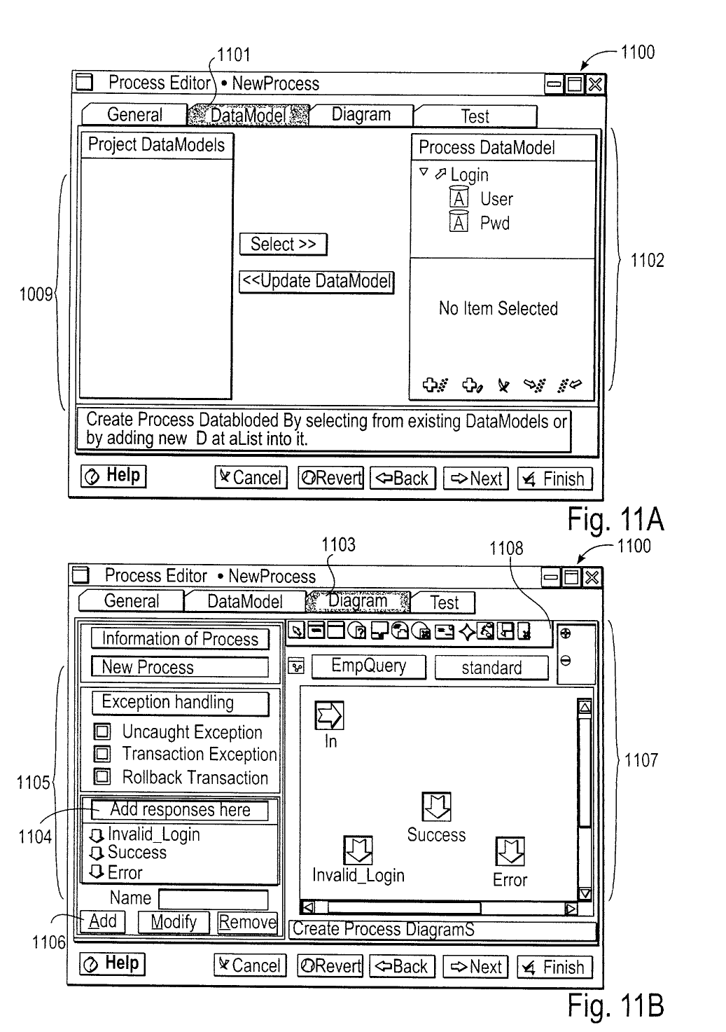

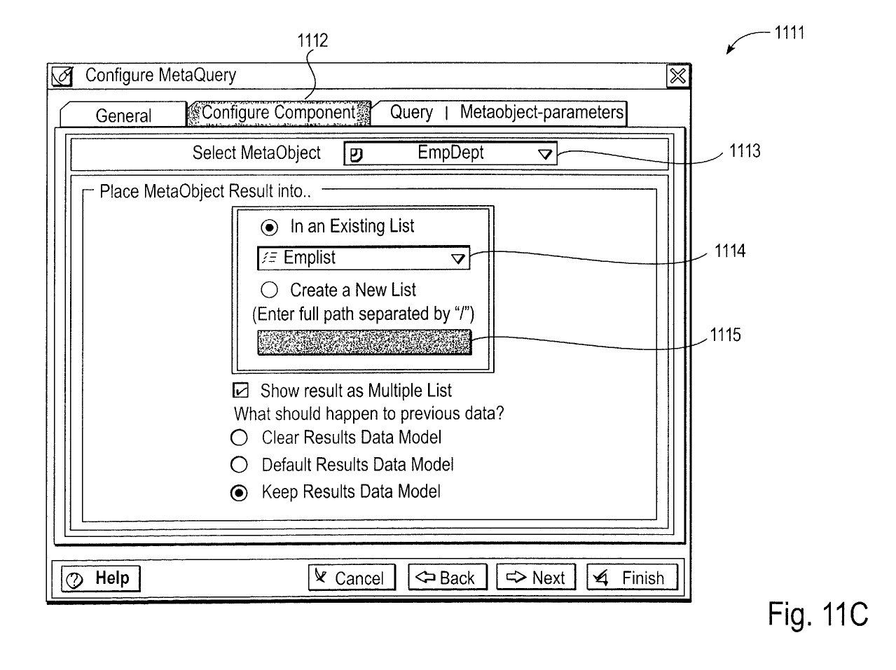

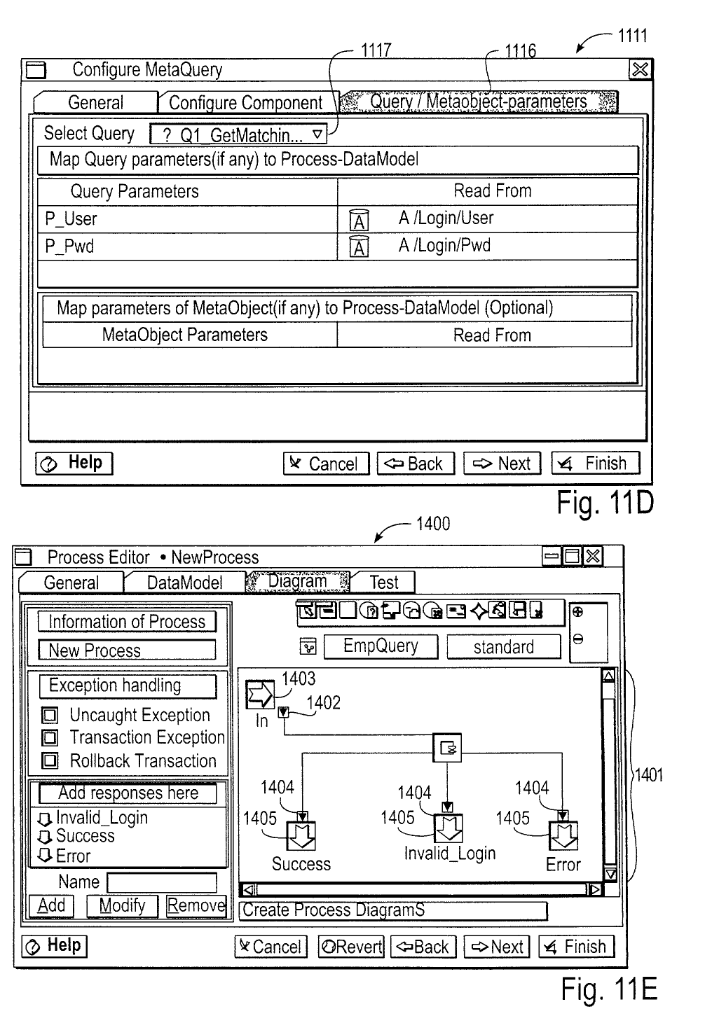

FIG. 11 is a flow diagram of one embodiment for a method for defining business logic within the application. FIGS. 11A-11E illustrate exemplary interfaces to define the application business logic.

As illustrated in FIG. 11, at processing block 1110, application business logic, for example a process, is defined for the application. In one embodiment, user 205 selects a process name in a window displayed by the process editor 427 within user interface module 222.

At processing block 1120, a first data model structure is defined for the process. In one embodiment, user 205 defines the first data model structure through data model editor 429 within user interface module 222.

Referring to FIG. 11A, in one embodiment, user 205 selects a Data Model tab 1101 within a third user interface area, for example interface 1100, with a conventional mouse click. In one embodiment, the first data model structure 425 to be defined is a process data model structure. Interface 1100 displays a Process Data Model window 1102 containing the available process data model structures 425 stored within client 220. Next, user 205 defines a new process data model structure 425 in window 1102.

As illustrated in FIG. 11, at processing block 1130, a set of responses is defined for the process. In one embodiment, user 205 defines the set of responses 520 for process 428 through process editor 427 within user interface module 222.

Referring to FIG. 11B, in one embodiment, user 205 selects a Diagram tab 1103 within interface 1100 with a conventional mouse click. Interface 1100 displays multiple windows, buttons, and fields to allow user 205 to define the set of responses 520. In one embodiment, user 205 inputs a name for a first response 520 in an Add Responses Here field 1104 within a window 1105 displayed within interface 1100. Next user 205 presses an Add button 1106 within window 1105 to add the newly defined response 520 to process 428. In one embodiment, the response 520 is displayed as a response icon in a window 1107 within interface 1100. In one embodiment, other responses may be defined within field 1104 for process 428.

As illustrated in FIG. 11, at processing block 1140, a set of components is created for the process. In one embodiment, user 205 creates the set of components 422 through component editor 423 within user interface module 222.

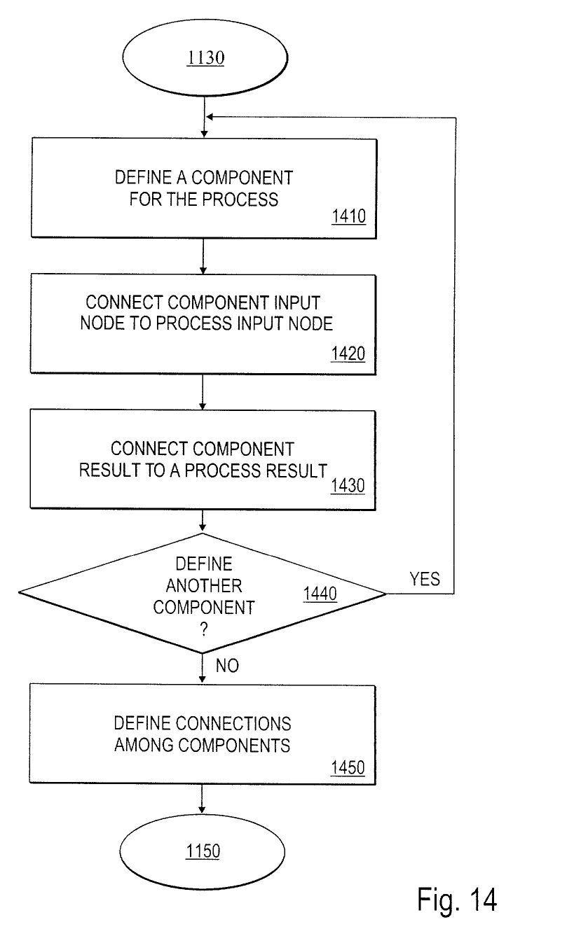

Referring to FIG. 11B, in one embodiment, user 205 uses a component toolbar 1108 within interface 1100 to create each component 422 of process 428. The creation of components 422 will be described in further detail below in connection with FIGS. 11C-11E and FIG. 14.

As illustrated in FIG. 11, at processing block 1150, a second data model structure is defined for the project. In one embodiment, user 205 defines a second data model structure 425, for example a project data model structure, through data model editor 429 within user interface module 222.

Referring to FIG. 11A, in one embodiment, user 205 selects the Data Model tab 1101 within interface 1100 with a conventional mouse click. Interface 1100 displays a window 1109, for example a Project Data Model window. In one embodiment, user 205 uses the Project Data Model window 1109 to define the project data model structure 425.

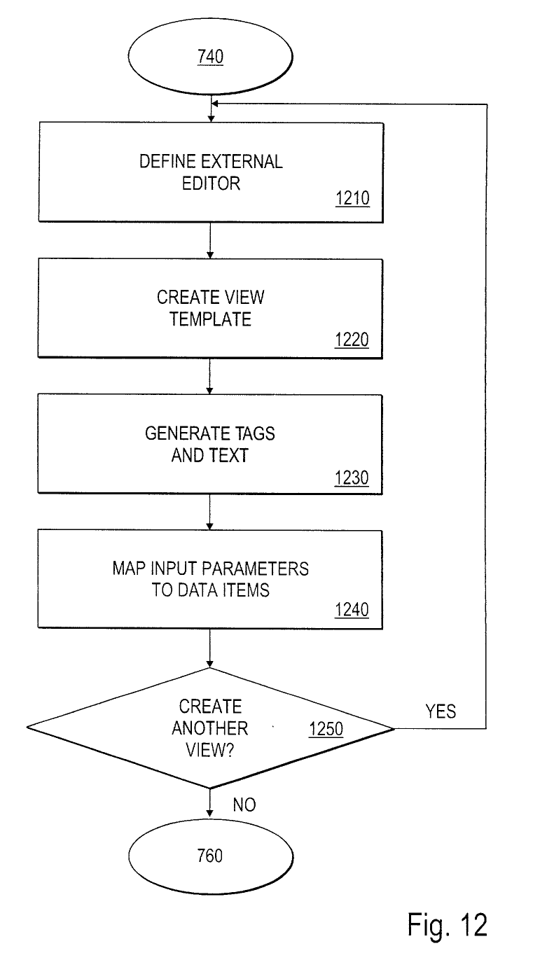

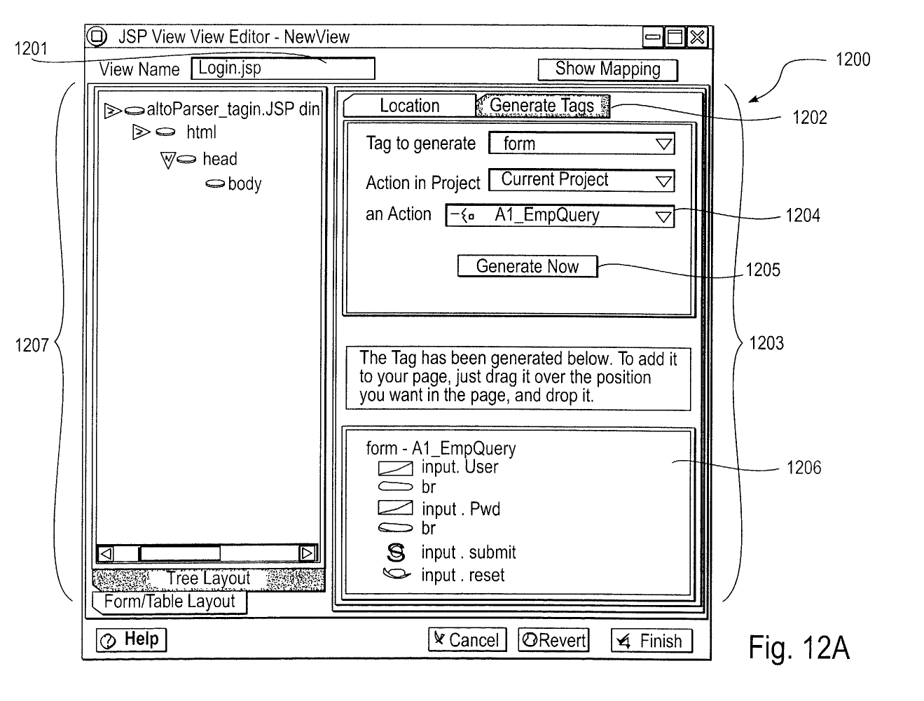

FIG. 12 is a flow diagram of one embodiment for a method for creating presentation logic within the application. FIG. 12A illustrates an exemplary interface to create the presentation logic.

As illustrated in FIG. 12, at processing block 1210, an external editor is defined for the application. In one embodiment, user 205 defines the external editor through user interface module 222 within client 220. User 205 types a path to the external editor in a window displayed by user interface module 222 in the user browser. In one embodiment, the external editor is used to create and/or modify HTML code for the views 432.

At processing block 1220, a view template is created. In one embodiment, user 205 creates an HTML template for a view 432 through view editor 433 within user interface module 222.

Referring to FIG. 12A, in one embodiment, user 205 creates the template using a fourth user interface area, for example interface 1200. User 205 inputs a name for view 432 in a View Name field 1201 within interface 1200. In one embodiment, in order to populate the HTML view template with text and tags, user 205 uses the previously defined external editor.

In one embodiment, a window 1207 within interface 1200 displays a structure for the HTML view template, for example a tree structure, containing multiple nodes, for example a head node and a body node.

As illustrated in FIG. 12, at processing block 1230, text and tags are generated for the view template. In one embodiment, user 205 inputs the text and generates the tags through view editor 433 within user interface module 222.

Referring to FIG. 12A, in one embodiment, user 205 selects a Generate Tags tab 1202 within interface 1200. Interface 1200 displays a window 1203 to allow user 205 to generate the tags, which enable the view 432 to write dynamic data.

In one embodiment, user 205 selects an action 434 with a conventional mouse click from a Trigger an Action drop-down list 1204 and presses a Generate Now button 1205 with another mouse click to generate a tag. In one embodiment, parameters for the generated tag are displayed in a window 1206.

As illustrated in FIG. 12, at processing block 1240, input parameters are mapped to data items within the defined process data model structure. In one embodiment, user 205 maps input parameters in the view template to the process data model structure 425 through view editor 433 within user interface module 222.

Referring to FIG. 12A, in one embodiment, user 205 drags the generated tag displayed in window 1206 and drops it on a node displayed within window 1207, for example the body node. Next, user 205 expands the body node with a conventional mouse click to display the generated tag within window 1207 and presses a Show Mapping button 1208 within interface 1200 to map the input from the view 432 to the process data model structure 425.

As illustrated in FIG. 12, at processing block 1250, a decision is made whether another view needs to be created. If another view needs to be created for the application, processing blocks 1210 through 1240 are repeated. In one embodiment, user 205 repeats the steps associated with processing blocks 1210 through 1240 and communicates with view editor 433 within user interface module 222 to create another view. Otherwise, if no other view needs to be created, the procedure continues with the integration of the application.

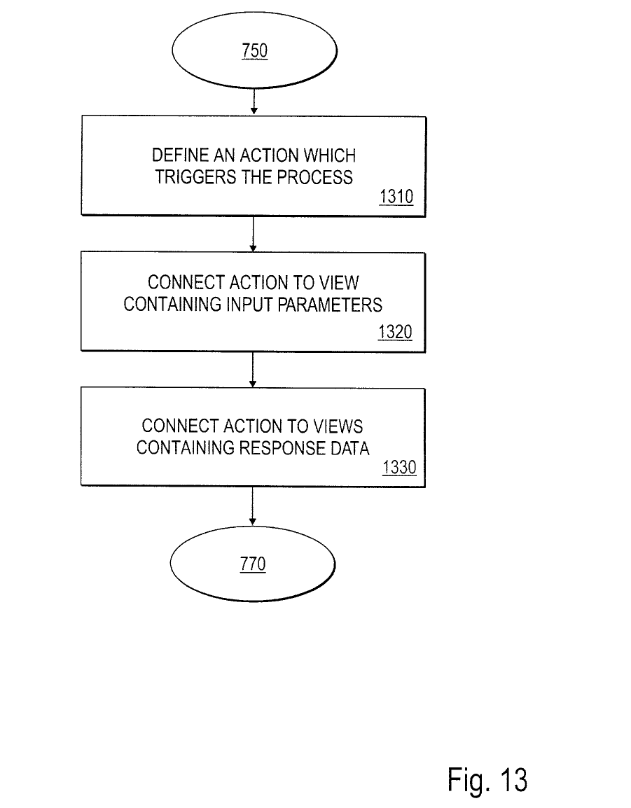

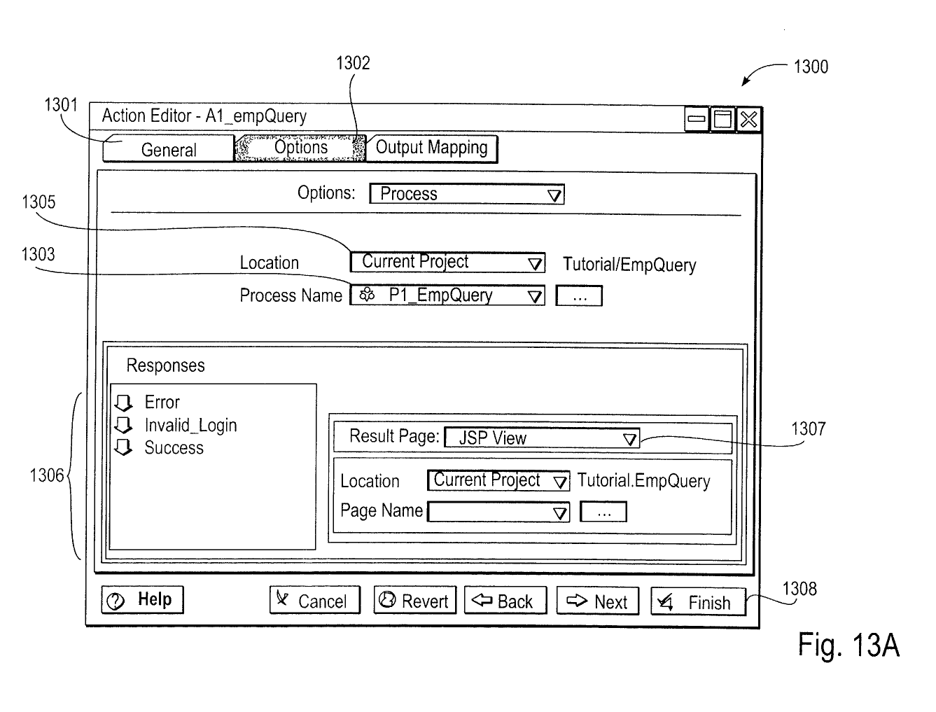

FIG. 13 is a flow diagram of one embodiment for a method for integrating the application within the system for accessing, organizing, and presenting data. FIG. 13A illustrates an exemplary interface to integrate the application within the system.

As illustrated in FIG. 13, at processing block 1310, an action is defined, the action being configured to trigger the defined process. In one embodiment, user 205 defines the action 434 through action editor 435 within user interface module 222.

Referring to FIG. 13A, in one embodiment, user 205 selects a General tab 1301 within a fifth user interface area, for example interface 1300, with a conventional mouse click and inputs a name for the action 434. Subsequently, user 205 selects an Options tab 1302 within interface 1300. Interface 1300 displays multiple windows and fields to allow user 205 to define parameters for the action 434.

In one embodiment, user 205 selects the process 428 to be triggered by the action 434 from a drop-down list 1303 of processes. An Options field 1304 and a Location field 1305 contain default settings. For example, the Options field 1304 contains a default Process setting and the Location field 1305 contains a default Current Project setting. In one embodiment, responses 520 for process 428 are displayed in a window 1306 within interface 1300.

As illustrated in FIG. 13, at processing block 1320, the action is connected to a view containing input parameters. In one embodiment, user 205 connects the action 434 with a view 432 containing input parameters through action editor 435 and view editor 433 within user interface module 222.

Finally, at processing block 1330, the action is connected to one or more views containing response data. In one embodiment, user 205 connects the action 434 with one or more views 432 containing responses 520 through action editor 435 within user interface module 222.

Referring to FIG. 13A, in one embodiment, user 205 selects the Options tab 1302 within interface 1300. In window 1306, user 205 selects each response 520 with a mouse click and selects a corresponding view for the response 520 from a drop-down list 1307 containing views 432. Finally, user 205 presses Finish button 1308 with a conventional mouse click to connect the action 434 to the views 432 containing responses 520.

FIG. 14 is a flow diagram of one embodiment for a method for creating a set of components within the application. As illustrated in FIG. 14, at processing block 1410, a component is defined for the process. In one embodiment, user 205 defines each component of process 428 through component editor 423 within user interface module 222.

Referring to FIG. 11C, in one embodiment, after user 205 presses a Select Data button on the toolbar 1108 shown in FIG. 11B and is prompted to configure the component 422, a Configure Meta Query window 1111 is displayed within interface 1100.

In one embodiment, user 205 selects a Configure Component tab 1112 within window 1111 with a conventional mouse click. User 205 selects a data structure 414 from a drop-down list 1113 displayed within window 1111. Subsequently, in one embodiment, user 205 selects a list to place the data structure 414 from a drop-down list 1114 displayed within window 1111. Alternatively, user 205 may create a new list for the data structure 414 by entering a path to the list in a field 1115 within window 1111. In one embodiment, the list is added to the data model structure 425.

Referring to FIG. 11D, in one embodiment, user 205 selects a Query/Metaobject-parameters tab 1116 within window 1111 with a conventional mouse click. Using a drop-down list 1117 within window 1111, user 205 selects the operation or query and maps each data item within process data model structure 425 to a query parameter of the query.

As illustrated in FIG. 14, at processing block 1420, an input node for the defined component 422 is connected to the input node of process 428. In one embodiment, user 205 connects the input node of the defined component 422 with the input node of process 428 through process editor 427 within user interface module 222.

Referring to FIG. 11E, in one embodiment, interface 1100 displays diagram window 1107 containing icons illustrating process 428 and component 422. User 205 highlights the icon 1402 representing the input node of component 422 with a conventional mouse click and drags the icon 1402 to an icon 1403 representing the input node of process 428. In one embodiment, once the user 205 releases the mouse, a connection is made between the input node of component 422 and the input node of process 428.

As illustrated in FIG. 14, at processing block 1430, a result of component 422 is connected to a result of process 428. In one embodiment, user 205 connects each result of the defined component 422 with one result of process 428 through process editor 427 within user interface module 222.

Referring to FIG. 11E, in one embodiment, user 205 highlights an icon 1404 representing one result of component 422 with a conventional mouse click and drags the icon 1404 to an icon 1405 representing one result of process 428. In one embodiment, once the user 205 releases the mouse, a connection is made between the result of component 422 and the result of process 428. In a similar fashion, user 205 connects other results of component 422 with corresponding results of process 428.

As illustrated in FIG. 14, at processing block 1440, a decision is made whether a new component needs to be defined. If a new component 422 needs to be defined, processing blocks 1410 through 1430 are repeated. In one embodiment, user 205 repeats the steps of processing blocks 1410 through 1430 and communicates with component editor 423 and process editor 427 to define the new component.

Otherwise, if no new component needs to be defined, at processing block 1450, connections among the defined components 422 are defined. In one embodiment, user 205 defines connections among the components 422 through process editor 427 within user interface module 222.

Referring to FIG. 11E, in one embodiment, user 205 highlights an icon 1404 representing one result of component 422 with a conventional mouse click and drags the icon 1404 to an icon 1402 representing one input node of another component 422 (not shown). In one embodiment, once the user 205 releases the mouse, a connection is made between the result of component 422 and the input node of the other component 422 (not shown).

Finally, as illustrated in FIG. 14, the procedure continues with the definition of the project data model structure 425, described in connection with FIG. 11.

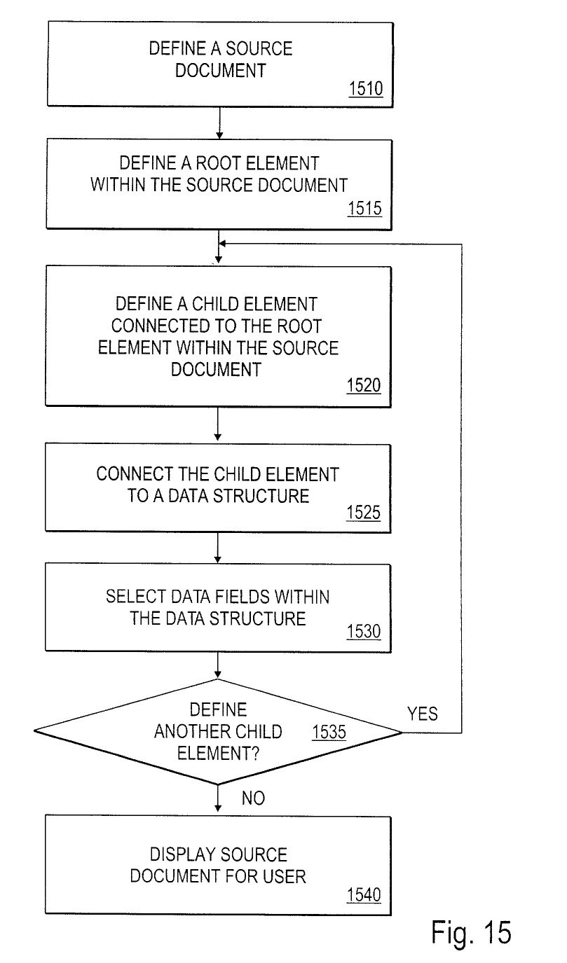

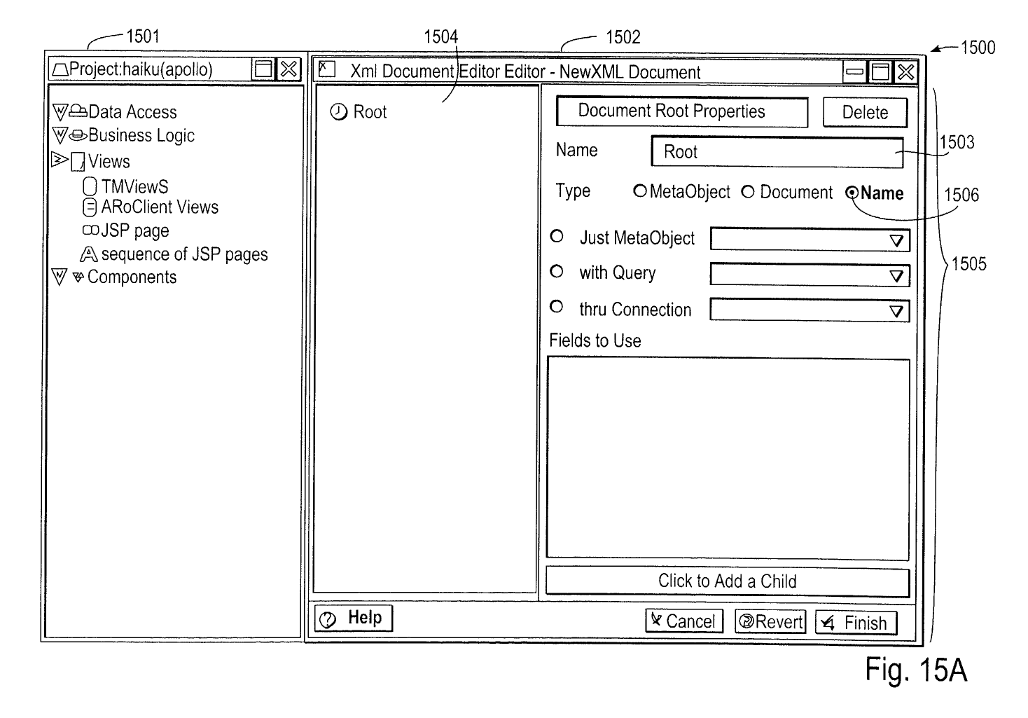

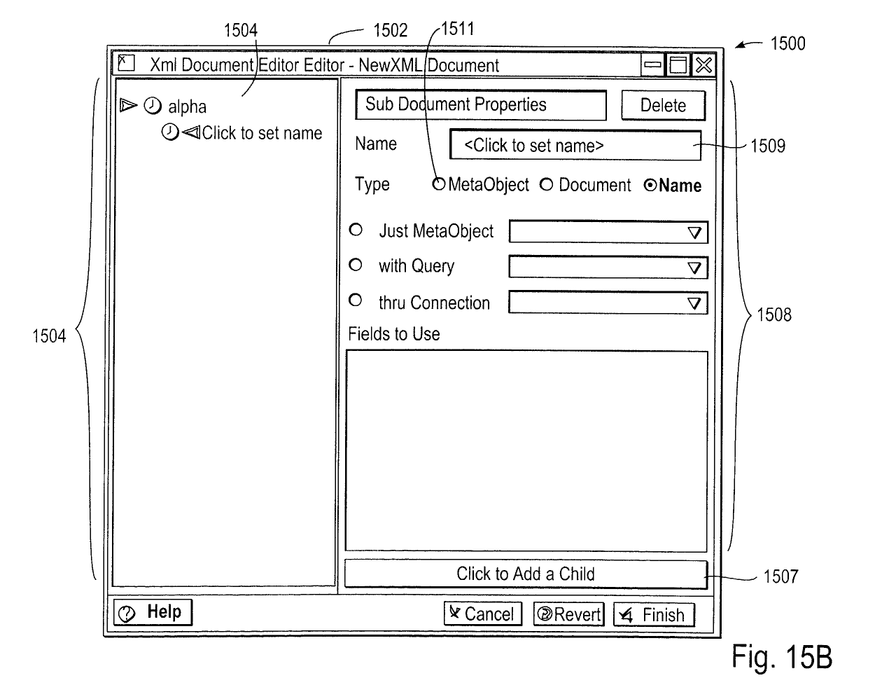

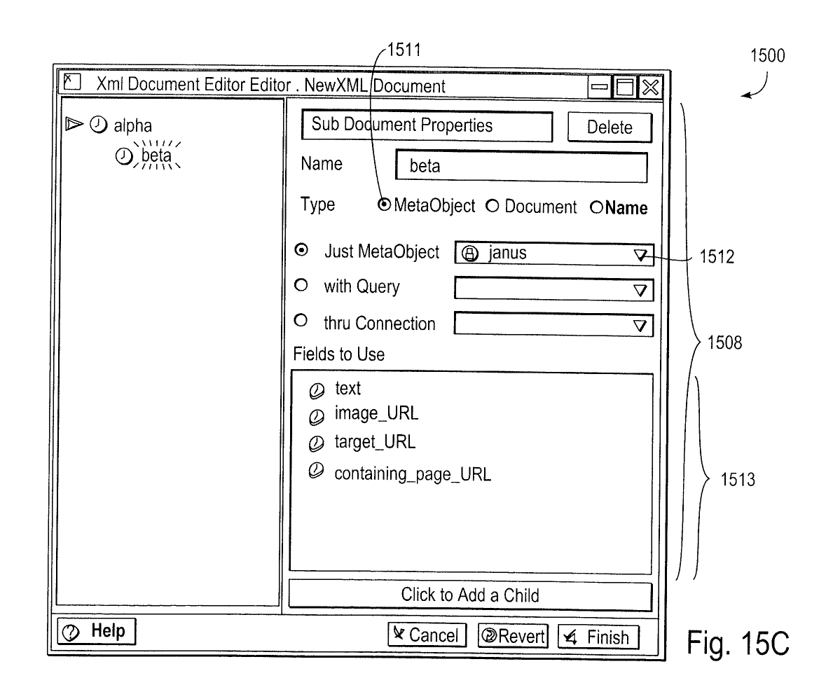

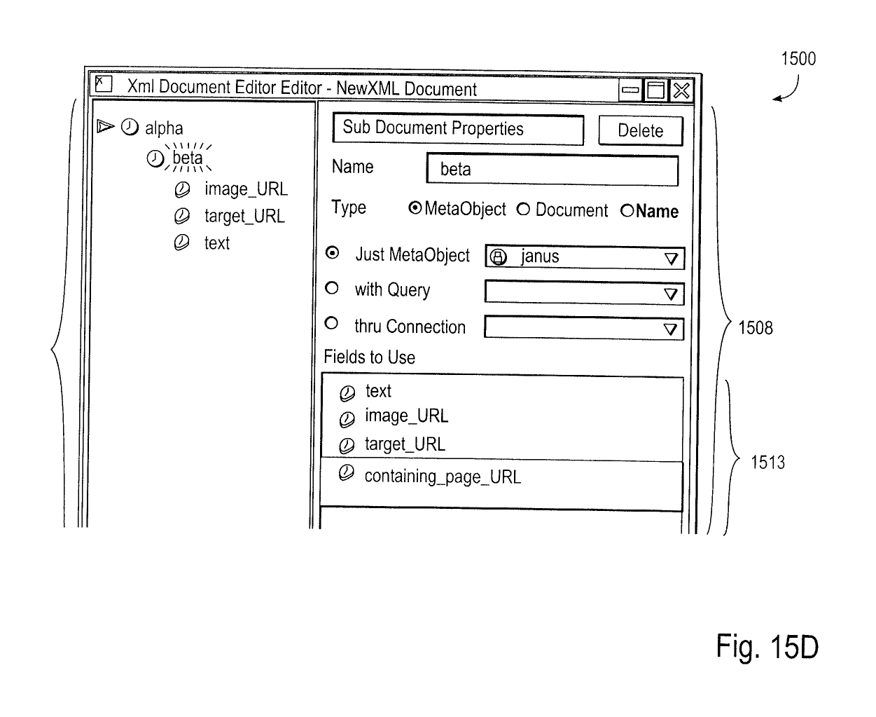

FIG. 15 is a flow diagram of one embodiment for a method for creating a source document within the application. FIGS. 15A-15D illustrate exemplary interfaces to create the source document.

As illustrated in FIG. 15, at processing block 1510, a source document is defined. In one embodiment, user 205 defines the source document, for example an XML document, through a construction editor, for example the XML editor 437, within the user interface module 222 of client 220.

Referring to FIG. 15A, in one embodiment, a construction user interface area, for example interface 1500, displays a project window 1501 containing a previously created project having multiple fields, for example a data access field, a business logic field, a views field, and a components field. In one embodiment, user 205 selects the views field and chooses to add a new XML document with a conventional right-click command. Interface 1500 displays a New XML Document window 1502 to allow user 205 to define the XML document. The new XML document will appear in a box 1504 within the New XML Document window 1502 as a hierarchical structure containing a root element and one or more child elements.

As illustrated in FIG. 15, at processing block 1515, a root element is defined within the source document. In one embodiment, the root element is the base of the hierarchical structure that defines the source document, for example the XML document. User 205 defines the root element through XML editor 437 within the user interface module 222.

Referring to FIG. 15A, user 205 enters a name for the root element of the XML document in a Name field 1503 within a Document Root Properties dialog box 1505 displayed in window 1502. Subsequently, user 205 selects a type for the root element from multiple type fields displayed within dialog box 1505. In one embodiment, user 205 selects a Name type field 1506 with a conventional mouse click. Alternatively, user 205 may select a MetaObject type field or a Document type field to indicate the type of the root element.

As illustrated in FIG. 15, at processing block 1520, a child element is defined for the source document, the child element being connected to the root element in the hierarchical structure. In one embodiment, user 205 defines the child element of the XML document through the XML editor 437 within the user interface module 222.

Referring to FIG. 15B, in one embodiment, user 205 presses a Click to Add a Child field 1507 within window 1502 with a conventional mouse click. Interface 1500 displays a Sub Document Properties dialog box 1508 within window 1502 to allow user 205 to define the child element of the XML document.

In one embodiment, user 205 enters a name for the child element in a Name field 1509 within dialog box 1508. Next, user 205 selects a type for the child element from multiple types displayed in dialog box 1508. In one embodiment, user 205 selects a MetaObject type field 1511 with a conventional mouse click. Alternatively, user 205 may select a Name type field or a Document type field to indicate the type of the child element. In one embodiment, the child element is displayed in the hierarchical structure shown in window 1504 and is connected to the root element of the XML document.

As illustrated in FIG. 15, at processing block 1525, the child element of the source document is connected to a data structure 414 within the application 400. In one embodiment, user 205 connects the child element of the XML document to data structure 414 through XML editor 437 within user interface module 222.

Referring to FIG. 15C, in one embodiment, user 205 selects a data structure 414 from a drop-down menu 1512 containing data structures 414 previously created within the application 400. After the user 205 selects the data structure 414, interface 1500 displays data sets of a data source, for example a web server HTML data source 265, associated with the data structure 414, as data fields in a Fields To Use box 1513 within dialog box 1508.

As illustrated in FIG. 15, at processing block 1530, data fields within the data structure are selected for the child element. In one embodiment, user 205 selects the data fields through the XML editor 437 within user interface module 222.

Referring to FIG. 15C, in one embodiment, using conventional mouse click commands, user 205 selects one or more data fields, associated with data structure 414 and displayed within the Fields To Use box 1513. As shown in FIG. 15D, user 205 places the selected data fields in the hierarchical structure displayed in window 1504 and positions the selected data fields under the corresponding child element within the hierarchical structure.

As illustrated in FIG. 15, at processing block 1535, a decision is made whether another child element needs to be defined. In one embodiment, if user 205 needs to define another child element for the XML document, user 205 repeats the steps associated with processing blocks 1520 through 1530 and communicates with the XML editor 437 to define another child element.

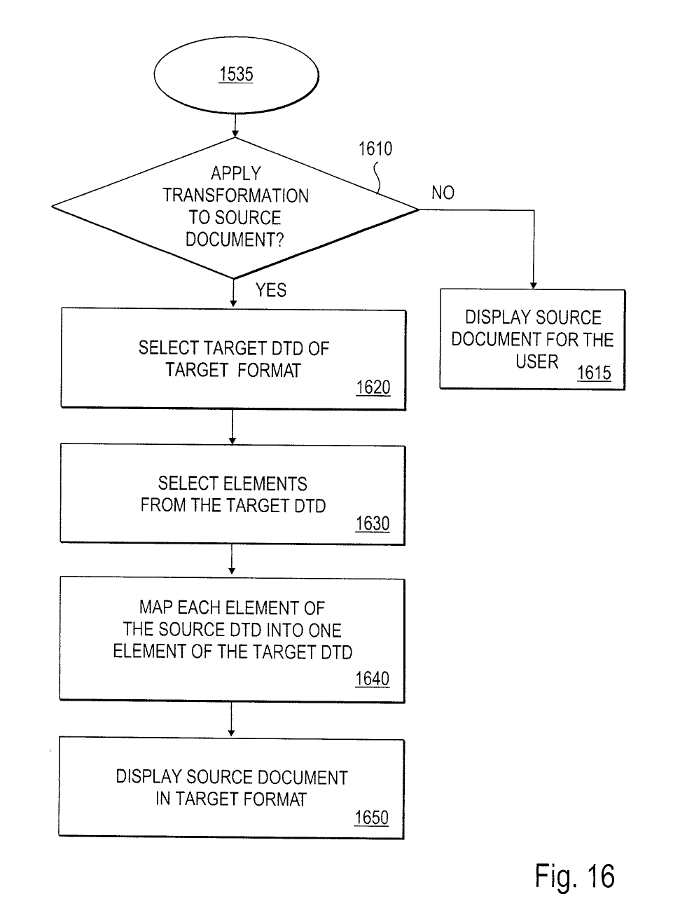

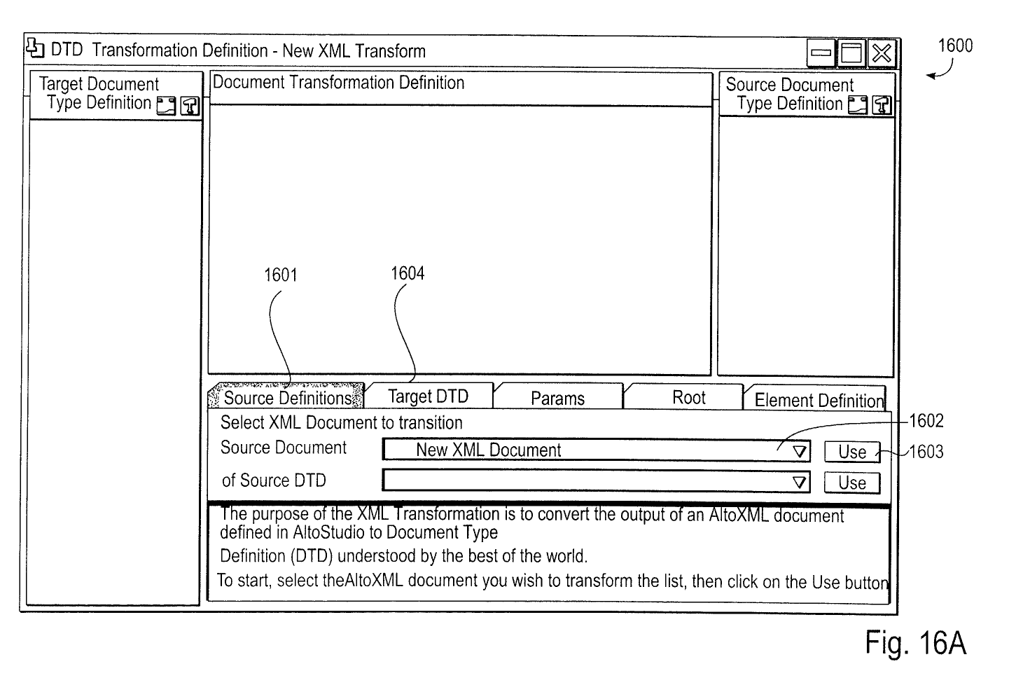

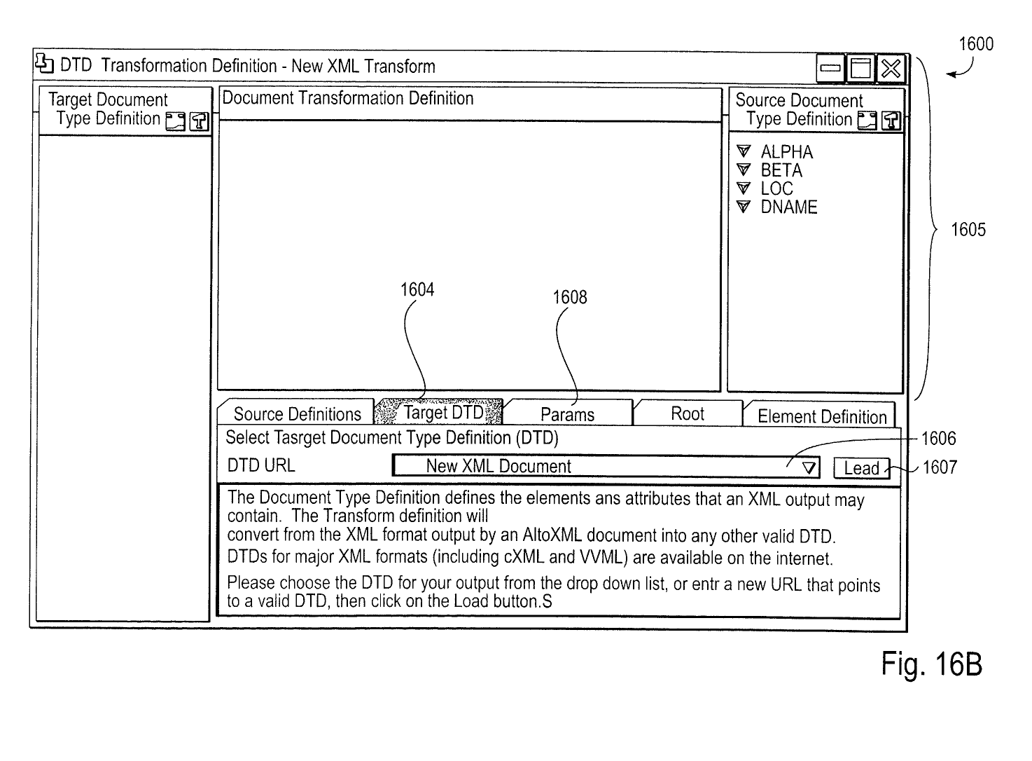

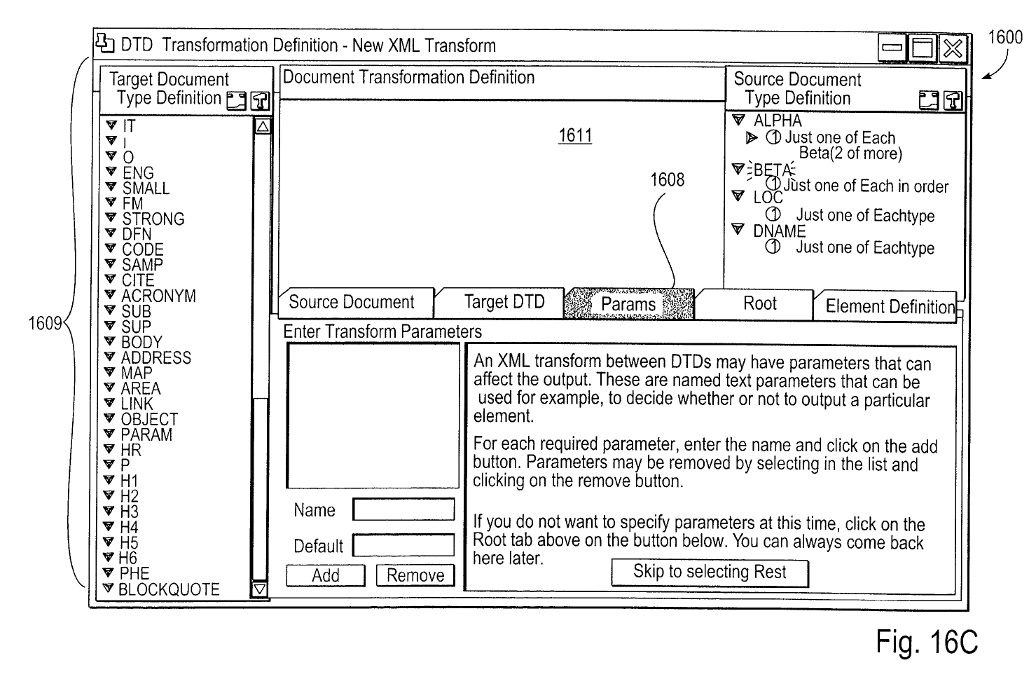

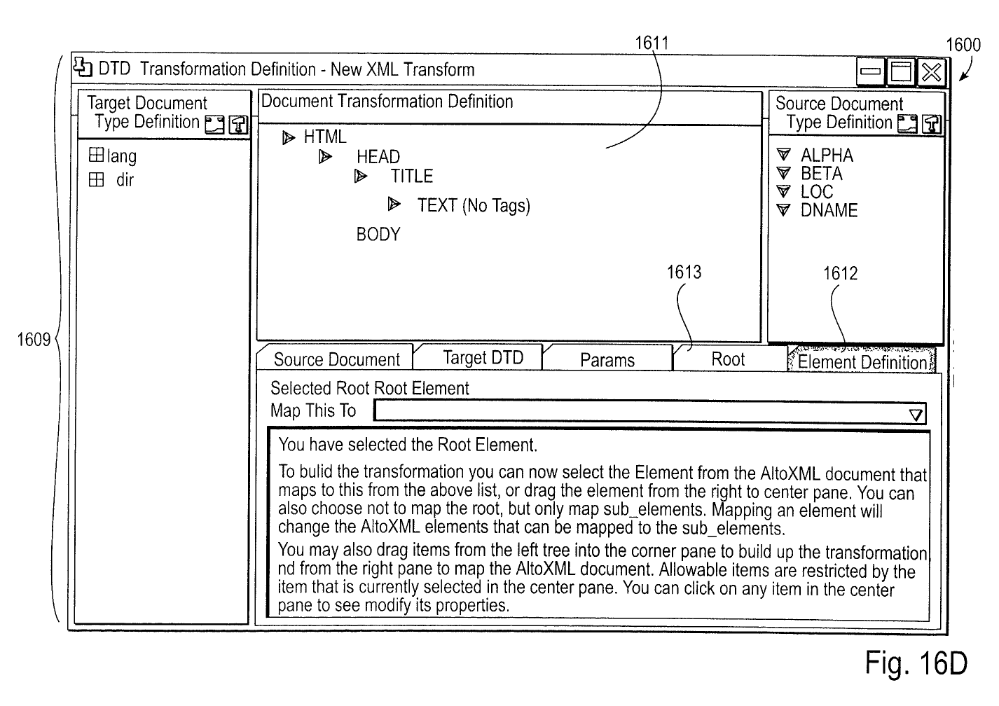

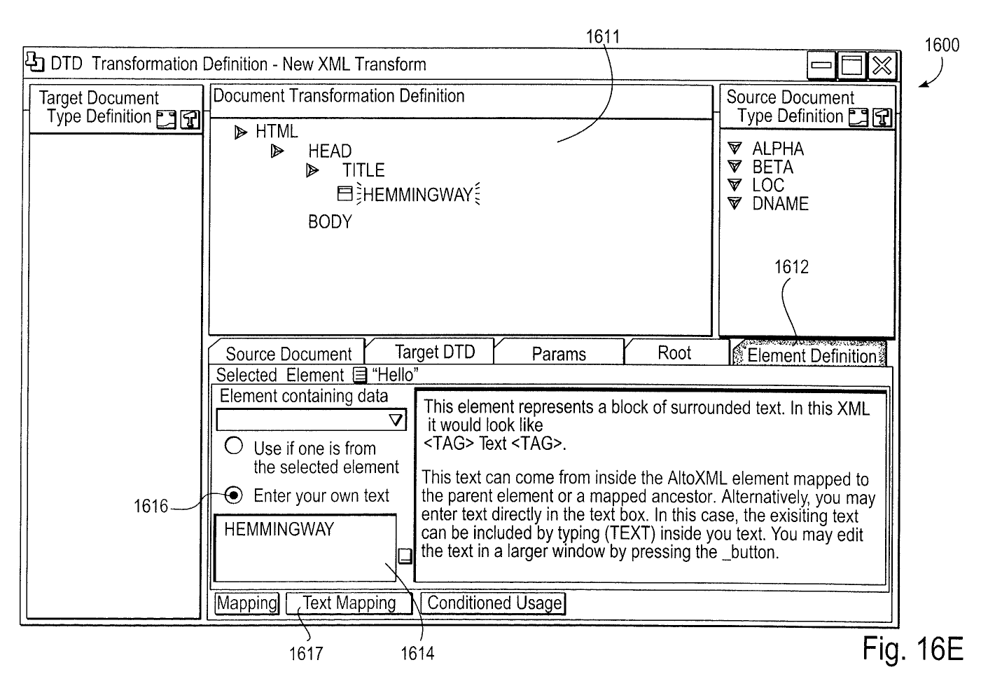

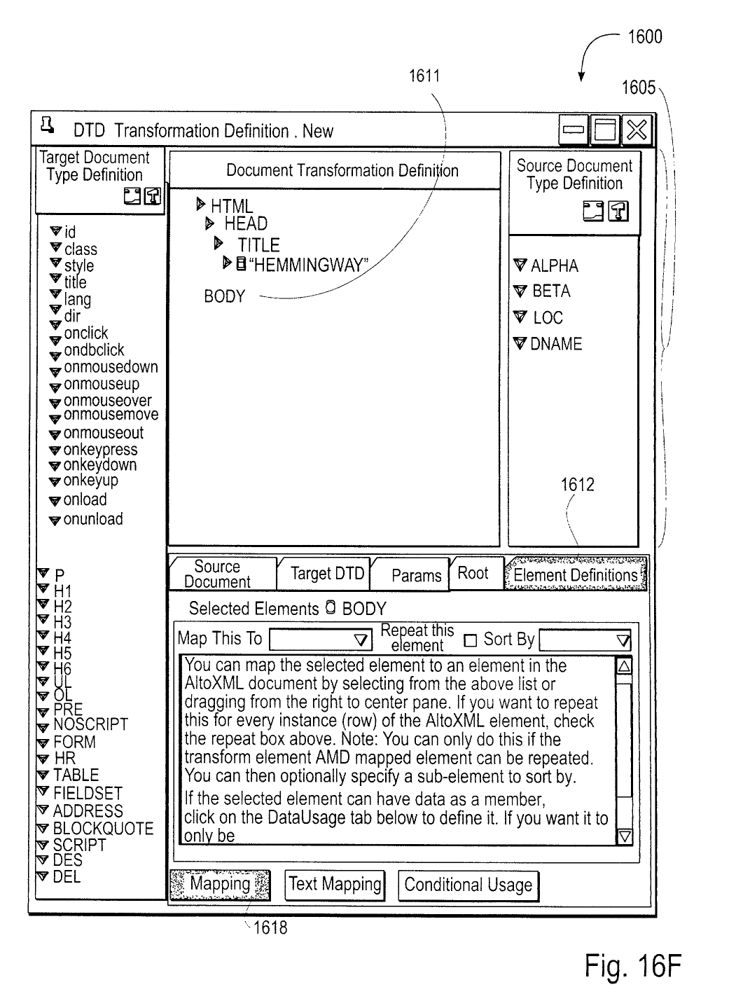

Otherwise, if no other child element needs to be defined, at processing block 1540, the source document is displayed for the user. Processing block 1540 will be described in further detail in connection with FIGS. 16, and 16A-16F.

FIG. 16 is a flow diagram of one embodiment for a method for converting the source document from a source format to a target format and presenting the source document to the user. FIGS. 16A-16F are exemplary interfaces to convert the source document to the target format and to present the source document to the user.

As illustrated in FIG. 16, at processing block 1610, a decision is made whether a transformation of the source document from the source format, for example XML, to a target format, for example HTML, needs to be applied. In one embodiment, if no transformation needs to be applied, at processing block 1615, the source document is displayed for the user 205 in a window within the user interface module 222.

Otherwise, at processing block 1620, a target Document Type Definition (DTD) of the target format is selected. In one embodiment, user 205 selects the target DTD through a conversion editor, for example the XML transform editor 436, within the user interface module 222.

In one embodiment, the target DTD is a specific definition that follows the rules of the Standard Generalized Markup Language (SGML). HTML is a type of DTD, which provides HTML tags to a document handler, for example a web browser designed to handle text documents encoded with the HTML tags.

In one embodiment, the XML Transform editor 436 uses procedures established by the World Wide Web Consortium (W3C), which promotes standards for the interoperability of the World Wide Web (WWW).

Referring to FIG. 16A, in one embodiment, the XML Transform editor 436 displays multiple windows within a conversion user interface area, for example interface 1600, to allow user 205 to select the target DTD. User 205 selects a Source Document tab 1601 within interface 1600 with a conventional mouse click. In one embodiment, interface 1600 displays a Source Document field 1602, which shows the source document created, for example the New XML document. Alternatively, user 205 may select other source documents previously developed from a drop-down menu within field 1602.

Next, in one embodiment, user 205 presses a Use button 1603 within interface 1600 in order to select a Target DTD tab 1604. As shown in FIG. 16B, interface 1600 displays multiple fields associated with the Target DTD tab 1604 in order to allow user 205 to select the target DTD. Interface 1600 further displays data developed in the XML document into a Source Document Type Definition window 1605.

Referring to FIG. 16B, in one embodiment, user 205 selects a Universal Resource Locator (URL) for the target DTD from a drop-down menu within a DTD URL field 1606 within interface 1600. Alternatively, user 205 may enter a specific URL for the target DTD in field 1606. In one embodiment, the URLs within the drop-down menu of field 1606 are downloaded from the W3C via the World Wide Web. Alternatively, the DTD source may be hardcoded in server 104.

Subsequently, in one embodiment, user 205 presses a Load button 1607 within interface 1600 with a conventional mouse click to load the selected target DTD and to select a Params tab 1608 within interface 1600. As shown in FIG. 16C, interface 1600 displays fields associated with the Params tab 1608 to allow user 205 to select parameters for the transformation, for example text parameters which can be used to decide whether to output particular elements of the XML document. Interface 1600 further displays data elements associated with the selected URL of the target DTD in a Target Document Type Definition window 1609.

As illustrated in FIG. 16, at processing block 1630, data elements are selected from the target DTD. In one embodiment, user 205 selects the target data elements through the XML Transform editor 436 within the user interface module 222.

Referring to FIG. 16C, in one embodiment, the target data elements are displayed in a list within the Target Document Type Definition window 1609. User 205 selects one or more data elements and places the data elements into a Document Transform Definition window 1611 within interface 1600 using drag-and-drop functionality and conventional mouse clicks.

For example, as shown in FIG. 16D, user 205 selects a target root element HTML from the list displayed in window 1609 and places it within window 1611. User 205 may also select other target data elements, for example target child elements, such as HEAD, TITLE, and BODY, and place them within window 1611 in a hierarchical structure.

Referring to FIG. 16D, in one embodiment, user 205 selects an Element Definition tab 1612 within interface 1600. Interface 1600 displays fields associated with the Element Definition tab to allow user 205 to select and define an element within Document Transform Definition window 1611 or to enter text information within window 1611. Alternatively, if a target root element cannot be found within the list displayed in window 1609, user 205 may select a Root tab 1613 within interface 1600 to establish a target root element within the Document Transform Definition window 1611.

As shown in FIG. 16E, in one embodiment, user 205 selects an element within window 1611 using a conventional mouse click, presses an Enter Your Own Text button 1616, and enters text in a text box 1614 activated by pressing the button 1616. Next, user 205 presses a Text Mapping button 1617 to transfer the text to the corresponding element within window 1611.

As illustrated in FIG. 16, at processing block 1640, each element of the source DTD is mapped into one element of the target DTD. In one embodiment, user 205 maps the elements of the source DTD into the elements of the target DTD through XML Transform editor 436 within user interface module 222.

Referring to FIG. 16F, in one embodiment, user 205 selects one element within the Document Transform Definition window 1611, for example the element BODY. Interface 1600 populates the fields associated with the Element Definition tab 1612. In one embodiment, user 205 selects a Mapping tab 1618 with a conventional mouse click. The Mapping tab 1618 is used to map one element from the list displayed within the Source Document Type Definition 1605 to the selected BODY element within the Document Transform Definition window 1611. User 205 may perform the mapping by dragging and dropping the desired elements.

Finally, as illustrated in FIG. 16, at processing block 1650, the source document is displayed in the target format for the user.

It is to be understood that embodiments of this invention may be used as or to support software programs executed upon some form of processing core (such as the CPU of a computer) or otherwise implemented or realized upon or within a machine or computer readable medium. A machine readable medium includes any mechanism for storing or transmitting information in a form readable by a machine (e.g., a computer). For example, a machine readable medium includes read-only memory (ROM); random access memory (RAM); magnetic disk storage media; optical storage media; flash memory devices; electrical, optical, acoustical or other form of propagated signals (e.g., carrier waves, infrared signals, digital signals, etc.); or any other type of media suitable for storing or transmitting information.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method for facilitating definition of an application to provide data from a plurality of disparate data sources to a user, the method comprising:
presenting a first user interface area to enable said user to define a data reference structure for at least one data source of said plurality of disparate data sources, said at least one data source containing said data;
presenting a second user interface area to enable said user to create at least one data structure corresponding to said data reference structure and connected to said at least one data source; and
presenting a third user interface area to enable said user to define application business logic to be performed on said data in connection with said at least one data structure.

2. The method according to claim 1, further comprising presenting a fourth user interface area to enable said user to create presentation logic to display said data in an output view.

3. The method according to claim 1, wherein said user defines an application server coupled to said at least one data source and connects to said application server to access said data.

4. The method according to claim 1, wherein presenting said first user interface area further comprises:
facilitating selection of said at least one data source for said data reference structure; and
facilitating creation of a connection from said data reference structure to said at least one data source.

5. The method according to claim 4, wherein presenting said first user interface area further comprises:
facilitating verification of access to said at least one data source using said data reference structure.

6. The method according to claim 4, wherein said data reference structure is configured to specify connection information for said connection to said at least one data source.

7. The method according to claim 4, wherein facilitating selection of said at least one data source further comprises:
facilitating selection of a data source type of said at least one data source; and
facilitating selection of said at least one data source based on said selected data source type.

8. The method according to claim 1, wherein said at least one data structure is configured to identify said data within said at least one data source and to perform at least one predetermined operation on said data.

9. The method according to claim 1, wherein presenting said second user interface area further comprises:
facilitating definition of a reference link to said at least one data source; and
facilitating definition of a plurality of operation parameters within said at least one data structure, said plurality of operation parameters to form at least one operation to be performed on said data.

10. The method according to claim 9, wherein presenting said second user interface area further comprises:
facilitating creation of a relationship among said at least one data structure.

11. The method according to claim 9, wherein said reference link provides a reference to said at least one data source within said at least one data structure.

12. The method according to claim 9, wherein presenting said second user interface area further comprises:
facilitating definition of at least one connection among said at least one data source.

13. The method according to claim 9, wherein said at least one operation is a query to retrieve said data from said at least one data source based on a plurality of input parameters received from said user and to return said data to said user.

14. The method according to claim 13, wherein each operation parameter of said plurality of operation parameters is a query parameter of said query, and wherein each input parameter of said plurality of input parameters is mapped into said query parameter.

15. The method according to claim 9, wherein facilitating definition of said plurality of operation parameters further comprises:
facilitating definition of a parameter type for each operation parameter of said plurality of operation parameters;
facilitating definition of a plurality of parameter fields for said each operation parameter; and
facilitating input of a default value for each parameter field of said plurality of parameter fields.

16. The method according to claim 1, wherein presenting said third user interface area further comprises:
facilitating definition of a set of components for said application business logic; and
facilitating definition of a set of responses for said application business logic, each response of said set of responses being associated with an output view and containing said data.

17. The method according to claim 16, wherein presenting said third user interface area further comprises:
facilitating definition of a first data model structure to store a plurality of input parameters received from said user.

18. The method according to claim 16, wherein facilitating definition of said set of responses further comprises:
presenting a window area to enable said user visually to create a plurality of response icons, each response icon of said plurality of response icons corresponding to one response of said set of responses.

19. The method according to claim 18, wherein facilitating definition of said set of components further comprises:
presenting said window area to enable said user to visually create a plurality of component icons, each component icon of said plurality of component icons corresponding to one component of said set of components, said window area further containing an input node icon for said application business logic.

20. The method according to claim 19, wherein facilitating definition of said set of components further comprises:
facilitating visual creation of an input connection between a component input node icon of said each component icon and said input node icon for said application business logic; and
facilitating visual creation of an output connection between each component result icon of said each component icon and one response icon of said plurality of response icons.

21. The method according to claim 16, wherein presenting said third user interface area further comprises:
facilitating definition of a second data model structure to exchange said data with said application business logic.

22. The method according to claim 2, wherein presenting said fourth user interface area further comprises:
facilitating creation of a view template for said output view; and
facilitating generation of text and tags for said view template.

23. The method according to claim 22, wherein said view template is a Hyper Text Markup Language (HTML) view template.

24. The method according to claim 22, wherein said tags enable said output view to write dynamic data.

25. The method according to claim 22, wherein presenting said fourth user interface area further comprises:
facilitating visual mapping of said tags to each node of a plurality of nodes of said view template.

26. The method according to claim 1, further comprising presenting a fifth user interface area to enable said user to define an action within said application, said action being configured to trigger said application business logic.

27. The method according to claim 26, wherein presenting said fifth user interface area further comprises:
facilitating connection of said action to at least one input view containing a plurality of input parameters from said user; and
facilitating connection of said action to an output view containing a set of responses of said application business logic.

28. A system for facilitating definition of an application to provide data from a plurality of disparate data sources to a user, the system comprising:
means for presenting a first user interface area to enable said user to define a data reference structure for at least one data source of said plurality of disparate data sources, said at least one data source containing said data;
means for presenting a second user interface area to enable said user to create at least one data structure corresponding to said data reference structure and connected to said at least one data source; and
means for presenting a third user interface area to enable said user to define application business logic to be performed on said data in connection with said at least one data structure.

29. The system according to claim 28, further comprising means for presenting a fourth user interface area to enable said user to create presentation logic to display said data in an output view.

30. The system according to claim 28, wherein said user defines an application server coupled to said at least one data source and connects to said application server to access said data.

31. The system according to claim 28, further comprising:
means for facilitating selection of said at least one data source for said data reference structure; and
means for facilitating creation of a connection from said data reference structure to said at least one data source.

32. The system according to claim 31, further comprising:
means for facilitating verification of access to said at least one data source using said data reference structure.

33. The system according to claim 31, wherein said data reference structure is configured to specify connection information for said connection to said at least one data source.

34. The system according to claim 31, further comprising:
means for facilitating selection of a data source type of said at least one data source; and
means for facilitating selection of said at least one data source based on said selected data source type.

35. The system according to claim 28, wherein said at least one data structure is configured to identify said data within said at least one data source and to perform at least one predetermined operation on said data.

36. The system according to claim 28, further comprising:
means for facilitating definition of a reference link to said at least one data source; and
means for facilitating definition of a plurality of operation parameters within said at least one data structure, said plurality of operation parameters to form at least one operation to be performed on said data.

37. The system according to claim 36, further comprising:
means for facilitating creation of a relationship among said at least one data structure.

38. The system according to claim 36, wherein said reference link provides a reference to said at least one data source within said at least one data structure.

39. The system according to claim 36, further comprising:
means for facilitating definition of at least one connection among said at least one data source.

40. The system according to claim 36, wherein said at least one operation is a query to retrieve said data from said at least one data source based on a plurality of input parameters received from said user and to return said data to said user.

41. The system according to claim 40, wherein each operation parameter of said plurality of operation parameters is a query parameter of said query, and wherein each input parameter of said plurality of input parameters is mapped into said query parameter.

42. The system according to claim 36, further comprising:
means for facilitating definition of a parameter type for each operation parameter of said plurality of operation parameters;
means for facilitating definition of a plurality of parameter fields for said each operation parameter; and
means for facilitating input of a default value for each parameter field of said plurality of parameter fields.

43. The system according to claim 28, further comprising:
means for facilitating definition of a set of components for said application business logic; and
means for facilitating definition of a set of responses for said application business logic, each response of said set of responses being associated with an output view and containing said data.

44. The system according to claim 43, further comprising:
means for facilitating definition of a first data model structure to store a plurality of input parameters received from said user.

45. The system according to claim 43, further comprising:
means for presenting a window area to enable said user visually to create a plurality of response icons, each response icon of said plurality of response icons corresponding to one response of said set of responses.

46. The system according to claim 45, further comprising:
means for presenting said window area to enable said user to visually create a plurality of component icons, each component icon of said plurality of component icons corresponding to one component of said set of components, said window area further containing an input node icon for said application business logic.

47. The system according to claim 46, further comprising:
means for facilitating visual creation of an input connection between a component input node icon of said each component icon and said input node icon for said application business logic; and
means for facilitating visual creation of an output connection between each component result icon of said each component icon and one response icon of said plurality of response icons.

48. The system according to claim 43, further comprising:
means for facilitating definition of a second data model structure to exchange said data with said application business logic.

49. The system according to claim 29, further comprising:
means for facilitating creation of a view template for said output view; and
means for facilitating generation of text and tags for said view template.

50. The system according to claim 49, wherein said view template is a Hyper Text Markup Language (HTML) view template.

51. The system according to claim 49, wherein said tags enable said output view to write dynamic data.

52. The system according to claim 49, further comprising:
means for facilitating visual mapping of said tags to each node of a plurality of nodes of said view template.

53. The system according to claim 28, further comprising means for presenting a fifth user interface area to enable said user to define an action within said application, said action being configured to trigger said application business logic.

54. The system according to claim 53, further comprising:
means for facilitating connection of said action to at least one input view containing a plurality of input parameters from said user; and
means for facilitating connection of said action to an output view containing a set of responses of said application business logic.

55. A system for facilitating definition of an application to provide data from a plurality of disparate data sources to a user, the system comprising:
a data reference editor to present a first user interface area to enable said user to define a data reference structure for at least one data source of said plurality of disparate data sources, said at least one data source containing said data;
a data structure editor to present a second user interface area to enable said user to create at least one data structure corresponding to said data reference structure and connected to said at least one data source; and
a process editor to present a third user interface area to enable said user to define application business logic to be performed on said data in connection with said at least one data structure.

56. The system according to claim 55, further comprising a view editor to present a fourth user interface area to enable said user to create presentation logic to display said data in an output view.

57. The system according to claim 55, wherein said user defines an application server coupled to said at least one data source and connects to said application server to access said data.

58. The system according to claim 55, wherein said data reference editor further:
facilitates selection of said at least one data source for said data reference structure; and
facilitates creation of a connection from said data reference structure to said at least one data source.

59. The system according to claim 58, wherein said data reference editor further facilitates verification of access to said at least one data source using said data reference structure.

60. The system according to claim 58, wherein said data reference structure is configured to specify connection information for said connection to said at least one data source.

61. The system according to claim 58, wherein said data reference editor further:
facilitates selection of a data source type of said at least one data source; and
facilitates selection of said at least one data source based on said selected data source type.

62. The system according to claim 55, wherein said at least one data structure is configured to identify said data within said at least one data source and to perform at least one predetermined operation on said data.

63. The system according to claim 55, wherein said data structure editor further:
facilitates definition of a reference link to said at least one data source; and
facilitates definition of a plurality of operation parameters within said at least one data structure, said plurality of operation parameters to form at least one operation to be performed on said data.

64. The system according to claim 63, wherein said data structure editor further:
facilitates creation of a relationship among said at least one data structure.

65. The system according to claim 63, wherein said reference link provides a reference to said at least one data source within said at least one data structure.

66. The system according to claim 63, wherein said data structure editor further:
facilitates definition of at least one connection among said at least one data source.

67. The system according to claim 63, wherein said at least one operation is a query to retrieve said data from said at least one data source based on a plurality of input parameters received from said user and to return said data to said user.

68. The system according to claim 67, wherein each operation parameter of said plurality of operation parameters is a query parameter of said query, and wherein each input parameter of said plurality of input parameters is mapped into said query parameter.

69. The system according to claim 63, wherein said data structure editor further:
facilitates definition of a parameter type for each operation parameter of said plurality of operation parameters;
facilitates definition of a plurality of parameter fields for said each operation parameter; and
facilitates input of a default value for each parameter field of said plurality of parameter fields.

70. The system according to claim 55, wherein said process editor further:
facilitates definition of a set of components for said application business logic; and
facilitates definition of a set of responses for said application business logic, each response of said set of responses being associated with an output view and containing said data.

71. The system according to claim 70, further comprising a data model editor to facilitate definition of a first data model structure to store a plurality of input parameters received from said user.

72. The system according to claim 70, wherein said process editor further presents a window area to enable said user visually to create a plurality of response icons, each response icon of said plurality of response icons corresponding to one response of said set of responses.

73. The system according to claim 72, further comprises a component editor to present said window area to enable said user to visually create a plurality of component icons, each component icon of said plurality of component icons corresponding to one component of said set of components, said window area further containing an input node icon for said application business logic.

74. The system according to claim 73, wherein said component editor further:
facilitates visual creation of an input connection between a component input node icon of said each component icon and said input node icon for said application business logic; and
facilitates visual creation of an output connection between each component result icon of said each component icon and one response icon of said plurality of response icons.

75. The system according to claim 71, wherein said data model editor further facilitates definition of a second data model structure to exchange said data with said application business logic.

76. The system according to claim 56, wherein said view editor further:
facilitates creation of a view template for said output view; and
facilitates generation of text and tags for said view template.

77. The system according to claim 76, wherein said view template is a Hyper Text Markup Language (HTML) view template.

78. The system according to claim 76, wherein said tags enable said output view to write dynamic data.

79. The system according to claim 76, wherein said view editor further facilitates visual mapping of said tags to each node of a plurality of nodes of said view template.

80. The system according to claim 55, further comprising an action editor to present a fifth user interface area to enable said user to define an action within said application, said action being configured to trigger said application business logic.

81. The system according to claim 80, wherein said action editor further:
facilitates connection of said action to at least one input view containing a plurality of input parameters from said user; and
facilitates connection of said action to an output view containing a set of responses of said application business logic.

82. A computer readable medium containing executable instructions, which, when executed in a processing system, cause said processing system to perform a method for facilitating definition of an application to provide data from a plurality of disparate data sources to a user, the method comprising:
presenting a first user interface area to enable said user to define a data reference structure for at least one data source of said plurality of disparate data sources, said at least one data source containing said data;
presenting a second user interface area to enable said user to create at least one data structure corresponding to said data reference structure and connected to said at least one data source; and
presenting a third user interface area to enable said user to define application business logic to be performed on said data in connection with said at least one data structure.

83. The computer readable medium according to claim 82, wherein said method further comprises presenting a fourth user interface area to enable said user to create presentation logic to display said data in an output view.

84. The computer readable medium according to claim 82, wherein said user defines an application server coupled to said at least one data source and connects to said application server to access said data.

85. The computer readable medium according to claim 82, wherein presenting said first user interface area further comprises:
facilitating selection of said at least one data source for said data reference structure; and
facilitating creation of a connection from said data reference structure to said at least one data source.

86. The computer readable medium according to claim 85, wherein presenting said first user interface area further comprises:
facilitating verification of access to said at least one data source using said data reference structure.

87. The computer readable medium according to claim 85, wherein said data reference structure is configured to specify connection information for said connection to said at least one data source.

88. The computer readable medium according to claim 85, wherein facilitating selection of said at least one data source further comprises:
facilitating selection of a data source type of said at least one data source; and
facilitating selection of said at least one data source based on said selected data source type.

89. The computer readable medium according to claim 82, wherein said at least one data structure is configured to identify said data within said at least one data source and to perform at least one predetermined operation on said data.

90. The computer readable medium according to claim 82, wherein presenting said second user interface area further comprises:
facilitating definition of a reference link to said at least one data source; and
facilitating definition of a plurality of operation parameters within said at least one data structure, said plurality of operation parameters to form at least one operation to be performed on said data.

91. The computer readable medium according to claim 90, wherein presenting said second user interface area further comprises:
facilitating creation of a relationship among said at least one data structure.

92. The computer readable medium according to claim 90, wherein said reference link provides a reference to said at least one data source within said at least one data structure.

93. The computer readable medium according to claim 90, wherein presenting said second user interface area further comprises:
facilitating definition of at least one connection among said at least one data source.

94. The computer readable medium according to claim 90, wherein said at least one operation is a query to retrieve said data from said at least one data source based on a plurality of input parameters received from said user and to return said data to said user.

95. The computer readable medium according to claim 94, wherein each operation parameter of said plurality of operation parameters is a query parameter of said query, and wherein each input parameter of said plurality of input parameters is mapped into said query parameter.

96. The computer readable medium according to claim 90, wherein facilitating definition of said plurality of operation parameters further comprises:
facilitating definition of a parameter type for each operation parameter of said plurality of operation parameters;
facilitating definition of a plurality of parameter fields for said each operation parameter; and
facilitating input of a default value for each parameter field of said plurality of parameter fields.

97. The computer readable medium according to claim 82, wherein presenting said third user interface area further comprises:
facilitating definition of a set of components for said application business logic; and
facilitating definition of a set of responses for said application business logic, each response of said set of responses being associated with an output view and containing said data.

98. The computer readable medium according to claim 97, wherein presenting said third user interface area further comprises:
facilitating definition of a first data model structure to store a plurality of input parameters received from said user.

99. The computer readable medium according to claim 97, wherein facilitating definition of said set of responses further comprises:
presenting a window area to enable said user visually to create a plurality of response icons, each response icon of said plurality of response icons corresponding to one response of said set of responses.

100. The computer readable medium according to claim 99, wherein facilitating definition of said set of components further comprises:
presenting said window area to enable said user to visually create a plurality of component icons, each component icon of said plurality of component icons corresponding to one component of said set of components, said window area further containing an input node icon for said application business logic.

101. The computer readable medium according to claim 100, wherein facilitating definition of said set of components further comprises:
facilitating visual creation of an input connection between a component input node icon of said each component icon and said input node icon for said application business logic; and
facilitating visual creation of an output connection between each component result icon of said each component icon and one response icon of said plurality of response icons.

102. The computer readable medium according to claim 97, wherein presenting said third user interface area further comprises:
facilitating definition of a second data model structure to exchange said data with said application business logic.

103. The computer readable medium according to claim 83, wherein presenting said fourth user interface area further comprises:
facilitating creation of a view template for said output view; and
facilitating generation of text and tags for said view template.

104. The computer readable medium according to claim 103, wherein said view template is a Hyper Text Markup Language (HTML) view template.

105. The computer readable medium according to claim 103, wherein said tags enable said output view to write dynamic data.

106. The computer readable medium according to claim 103, wherein presenting said fourth user interface area further comprises:
facilitating visual mapping of said tags to each node of a plurality of nodes of said view template.

107. The computer readable medium according to claim 82, wherein said method further comprises presenting a fifth user interface area to enable said user to define an action within said application, said action being configured to trigger said application business logic.

108. The computer readable medium according to claim 107, wherein presenting said fifth user interface area further comprises:
facilitating connection of said action to at least one input view containing a plurality of input parameters from said user; and
facilitating connection of said action to an output view containing a set of responses of said application business logic.
